(19) United States
(12) Patent Application Publication
(10) Pub. No.: US 2025/0099992 A1
(43) Pub. Date: Mar. 27, 2025

(54) SPREADER SPRAYER

(71) Applicant: Greenworks (Jiangsu) Co., Ltd, Changzhou (CN)

(72) Inventors: Yin Chen, Changzhou (CN); Kaihong Tang, Changzhou (CN); Wei Wang, Changzhou (CN); Tao Zhang, Changzhou (CN); Kai Jiang, Changzhou (CN); Hailong Huang, Changzhou (CN); Chris Eichel, Mooresville, NC (US); Longfei Yang, Changzhou (CN)

(21) Appl. No.: 18/892,598

(22) Filed: Sep. 23, 2024

(30) Foreign Application Priority Data
Sep. 21, 2023 (CN) 202311223352.9
Sep. 21, 2023 (CN) 202322569750.8
Sep. 21, 2023 (CN) 202322578686.X
Sep. 21, 2023 (CN) 202322580350.7
Sep. 21, 2023 (CN) 202322581138.2
Sep. 21, 2023 (CN) 202322581576.9
Sep. 21, 2023 (CN) 202322581604.7
Sep. 21, 2023 (CN) 202322581672.3
Dec. 5, 2023 (CN) 202323311690.6

(51) Int. Cl. B05B 9/08; B05B 9/01; B05B 13/00; B05B 13/02

(52) U.S. Cl. CPC B05B 9/0861; B05B 9/01; B05B 13/005; B05B 13/0278

(57) ABSTRACT

A spreader sprayer includes a frame, a walking device, a spreading device, a spraying device and a controller assembly. The walking device includes a walking driving part. The spreading device includes a spreading driving part. The spraying device includes a spraying driving part. The controller assembly is electrically connected with the walking driving part, the spreading driving part and the spraying driving part respectively. The disclosure uses a power battery as a power source of a whole vehicle. The controller assembly can respond to user's operation to control a movement of the walking device, the spreading device and the spraying device.

### CROSS REFERENCE TO RELATED APPLICATION

The present application claims the priority of the following Chinese patent applications: serial No. CN202322581672.3, filed on Sep. 21, 2023, CN202323311690.6, filed on Dec. 5, 2023, CN202322581604.7, filed on Sep. 21, 2023, CN202322580350.7, filed on Sep. 21, 2023, CN202322581576.9, filed on Sep. 21, 2023, CN202322578686.X, filed on Sep. 21, 2023, CN202322569750.8, filed on Sep. 21, 2023, CN202322581138.2, filed on Sep. 21, 2023, CN202311223352.9, filed on Sep. 21, 2023; the disclosure of which is hereby incorporated by reference herein in its entirety for all purposes.

### TECHNICAL FIELD

The disclosure belongs to a technical field of garden tools, and in particular relates to a spreader sprayer.

### BACKGROUND

Conventional spreader sprayers have many defects in spraying devices, spreading devices and walking devices, such as that:
traditional spreader sprayers are generally powered by gasoline engines or diesel engines, and such spreader sprayers are noisy and have high maintenance costs. In addition, it is not compatible with some intelligent devices, making it difficult to develop various intelligent application scenarios based on actual needs.

Most spraying devices are fixed spraying rods with large size, single operation mode, and complex operation. Large agricultural machinery is not suitable for lawns, stadiums and green belts with complex terrain.

The hopper of the spreading device is generally a fixed structure. During inspection, repair and maintenance, the operating space is small due to the obstruction of the hopper, and the cost of repairing or replacing parts is high.

The spreading device cannot flexibly adjust the spreading density and spreading range, and is not suitable for complex terrain areas such as urban lawns, stadiums, green belts, etc.

The front wheels of the spreader sprayer are universal wheels. If the operator cannot achieve strict synchronous control of the two motors, or if the road surface is uneven, yaw is likely to occur.

### SUMMARY

One or more embodiments of the disclosure provide a spreader sprayer to solve at least some of defects mentioned above.

One or more embodiments of the disclosure provide a spreader sprayer. The spreader sprayer includes a frame, a walking device, a spreading device, a spraying device and a controller assembly. The walking device, the spreading device, the spraying device and the controller assembly are mounted on the frame.

The walking device includes a walking driving part.

The spreading device includes a spreading driving part.

The spraying device includes a spraying driving part.

The controller assembly is electrically connected with the walking driving part, the spreading driving part and the spraying driving part respectively.

The walking driving part, the spreading driving part and the spraying driving part are electric actuators respectively, a power battery is arranged on the frame, and the power battery is configured to provide electrical energy to the walking driving part, the spreading driving part and the spraying driving part.

In an embodiment of the disclosure, the spraying device further includes a vehicle-mounted chemical tank, a vehicle-mounted spraying assembly, a hand-held spraying gun, a main pipeline and a water divider valve assembly.

The vehicle-mounted chemical tank is used to store working fluid.

The vehicle-mounted spraying assembly is mounted on the frame and includes a plurality of spray nozzles.

One end of the main pipeline is communicated with the vehicle-mounted chemical tank, and the spraying driving part is connected in series to the main pipeline.

The water divider valve assembly includes a liquid inlet end and a plurality of liquid outlet ends, the liquid inlet end is communicated with the main pipeline, and each of the liquid outlet ends is respectively communicated with each spray nozzle of the vehicle-mounted spraying assembly and the hand-held spraying gun.

In an embodiment of the disclosure, the spreader sprayer further includes a return pipe and a stirring nozzle. The stirring nozzle is mounted in the vehicle-mounted chemical tank, a first end of the return pipe is communicated with the stirring nozzle, and a second end of the return pipe is connected with an upstream or a downstream of the water divider valve assembly.

In an embodiment of the disclosure, the water divider valve assembly includes a three-way valve and an electromagnetic water divider valve, the three-way valve includes a first port, a second port and a third port, the first port is communicated with the main pipeline, the second port is communicated with the hand-held spraying gun, and the third port is communicated with the electromagnetic water divider valve.

In an embodiment of the disclosure, a regulation valve and a flow meter are connected in series on a pipeline between the three-way valve and the electromagnetic water divider valve, the electromagnetic water divider valve is connected with a pressure sensor, and the electromagnetic water divider valve, the regulation valve, the flow meter and the pressure sensor are electrically connected with the controller assembly respectively.

In an embodiment of the disclosure, the spreader sprayer further includes a display screen. The display screen is electrically connected with the controller assembly, and is configured to at least display state information of the electromagnetic water divider valve and/or the regulation valve and/or the flow meter and/or the pressure sensor and driving information of the spreader sprayer.

In an embodiment of the disclosure, the walking device includes at least two driving wheels, the at least two driving wheels are arranged on two sides of the frame, two vehicle-mounted chemical tanks are provided, the two vehicle-mounted chemical tanks are respectively mounted above the two driving wheels, and an arc groove is arranged at a bottom of the vehicle-mounted chemical tank to avoid the driving wheels.

In an embodiment of the disclosure, the walking driving part includes a hub motor arranged in a rim of the driving wheel and a turning wheel mounted at a front end or a rear end of the frame.

In an embodiment of the disclosure, the spraying device further includes a fixing arm, a movable arm, a holding mechanism and a spraying head.

The fixing arm includes a mounting part to be connected with the frame.

At least one of the movable arms is movably mounted on at least one end of the fixing arm, the movable arm is configured to be switchable between a first position and a second position, and is capable of reducing a total length of the movable arm and the fixing arm in a first direction when the movable arm is switched from the first position to the second position, and the first direction is a width direction of the frame connected with the fixing arm.

The holding mechanism, mounted between the fixing arm and the movable arm, is configured to hold the movable arm in the first position when the movable arm is at the first position, and is configured to switch the movable arm to the second position and hold the movable arm at the second position when the movable arm is subjected to an external force in a second direction, and the second direction is a direction forming an angle with the first direction.

A plurality of the spraying heads is arranged on the fixing arm and the movable arm.

In an embodiment of the disclosure, the movable arm is hinged to an end part of the fixing arm through a first hinge shaft, a first limiting part and a second limiting part to limit a swinging angle of the movable arm are arranged between the movable arm and the fixing arm, the first limiting part is configured to block the movable arm at the first position when the movable arm swings from the second position to the first position, and the second limiting part is configured to block the movable arm at the second position when the movable arm swings from the first position to the second position.

In an embodiment of the disclosure, the spraying device further includes the fixing arm, the movable arm, the holding mechanism and the spraying head.

The fixing arm includes a mounting part to be connected with the frame.

At least one movable arms is movably mounted on at least one end of the fixing arm, the movable arm is configured to be switchable between a first position, a second position and a third position, and is capable of reducing a total length of the movable arm and the fixing arm in a first direction when the movable arm is switched from the first position to the second position or the third position, and the first direction is a width direction of the frame connected with the fixing arm.

The holding mechanism is mounted between the fixing arm and the movable arm, the holding mechanism is configured to hold the movable arm in the first position when the movable arm is at the first position, and holding mechanism is configured to switch the movable arm to a second position and hold the movable arm at the second position when the movable arm is subjected to an external force in the second direction, and holding mechanism is configured to switch the movable arm to a third position and hold the movable arm at the third position when the movable arm is subjected to an external force in the third direction, an angle between the second direction and the first direction is greater than 0° and less than 180°, and an angle between the third direction and the first direction is greater than 180° and less than 360°.

The plurality of the spraying heads is arranged on the fixing arm and the movable arm.

In an embodiment of the disclosure, the spraying device includes the vehicle-mounted chemical tank. The vehicle-mounted chemical tank includes a housing, a box cover and a water outlet connector.

The housing is surrounded and formed by a bottom wall, a plurality of side walls and a top wall, the bottom wall includes an arc-shaped wall, as well as a first bottom wall and a second bottom wall connected with two ends of the arc-shaped wall, the first bottom wall is lower than the second bottom wall, the first bottom wall and the second bottom wall are lower than an arc top of the arc-shaped wall, a drainage groove is arranged between the second bottom wall and the first bottom wall, the drainage groove is configured to enable liquid accumulated on the second bottom wall to flow to the first bottom wall through the drainage groove under an action of an gravity of the liquid, a water inlet is arranged on the top wall, and a water outlet is arranged on the first bottom wall.

The box cover is detachably mounted on the water inlet.

The water outlet connector is detachably mounted on the water outlet.

In an embodiment of the disclosure, the spreading device in mounted on the frame and includes a flip bracket, a hopper and a limiting mechanism.

The flip bracket is hinged to the frame.

The hopper is mounted on the flip bracket.

The limiting mechanism is arranged between the flip bracket and the frame, and is configured to limit a flipping angle of the flip bracket between a first angle and a second angle.

The hopper is configured such that a feeding port of the hopper faces upward when the flip bracket is located at the first angle, and the feeding port of the hopper faces downward when the flip bracket is located at the second angle.

In an embodiment of the disclosure, the spreading device includes a hopper, a movable door, an opening regulation mechanism and a spreading plate.

An upper end of the hopper is provided with a feeding port, and a lower end of the hopper is provided with a discharging port.

The movable door is mounted at the discharging port, and movably arranged relative to the hopper to enable the movable door to open or close the discharging port.

The opening regulation mechanism is mounted between the movable door and the hopper, and is configured to limit and regulate a moving path of the movable door to control an opening size of the discharging port.

The spreading plate is located below the discharging port, the spreading plate is rotatably arranged relative to the hopper, and is connected with the spreading driving part.

In an embodiment of the disclosure, the spreader sprayer further includes a landing regulation mechanism. The landing regulation mechanism includes a first guiding part and a second guiding part, the first guiding part is configured to guide materials discharged from the discharging port to a front half part of the spreading plate, the second guiding part is configured to guide the materials discharged from the discharging port to a rear half part of the spreading plate, the first guiding part and the second guiding part are mounted on a switching part, and the switching part is configured to be switchable between following two positions: position a and station b.

In the position a, the first guiding part is located on a discharging path of the discharging port.

In the station b, the second guiding part is located on the discharging path of the discharging port.

In an embodiment of the disclosure, the spreader sprayer further includes a shielding mechanism. The shielding mechanism includes a blocking plate arranged on at least one side of the spreading plate, and the blocking plate is movably arranged relative to the hopper to configure the blocking plate to be switched between following two states: state 1 and state 2.

In the state 1, the blocking plate shields a part of a spreading path of the spreading plate.

In the state 2, the blocking plate avoids the spreading path of the spreading plate.

In an embodiment of the disclosure, the walking device is mounted on the frame and includes a driving wheel, a turning wheel and a locking mechanism.

The turning wheel is rotatably arranged on a steering bracket, and the steering bracket is rotatably connected with the frame.

The locking mechanism is mounted between the steering bracket and the frame and is configured to be switchable between following two stations: locking station and releasing station.

In the locking station, the locking mechanism holds the steering bracket at a target steering angle when the steering bracket is at the target steering angle.

In the releasing station, the locking mechanism releases the steering bracket to enable the steering bracket to be freely turned.

In an embodiment of the disclosure, the frame is provided with a triggering mechanism, and the triggering mechanism is in a transmission connection with the locking mechanism through a transmission mechanism to drive the locking mechanism to switch between the locking station and the releasing station.

In an embodiment of the disclosure, the locking mechanism includes a first limiting unit and a second limiting unit, the first limiting unit includes a limiting pin fixedly connected with the steering bracket, the second limiting unit includes a locking base movably connected with the frame, a limiting groove is arranged on the locking base, and when the steering bracket is located at the target steering angle, the limiting pin is located on a moving path of the limiting groove to configure the limiting groove to be clamped with or separated from the limiting pin.

In an embodiment of the disclosure, the locking mechanism includes a guiding unit, a locking pin and a fourth elastic member.

The guiding unit is fixedly connected with the steering bracket, and is provided with a guiding surface smoothly arranged along the circumference of a first axis, and a locking hole is arranged on the guiding surface.

The locking pin is movably connected with the frame and is configured the locking pin to abut against or move away from the guiding surface, and when the locking pin abuts against the guiding surface, the locking pin is located on a rotation path of the locking hole when the locking hole rotates with the steering bracket.

The fourth elastic member is configured to generate an elastic force directed toward the guiding surface to the locking pin at least when the locking pin abuts against the guiding surface, in order to configure the locking pin to be inserted into the locking hole under an action of the elastic force when the locking hole is aligned with the locking pin.

Beneficial effects of one or more embodiments of the disclosure are that:
the power battery is adopted as a power source of a whole vehicle. The controller assembly can respond to user's operation to control a movement of the walking device, the spreading device and the spraying device. A structure of the spreader sprayer is more compact, and a flexibility of the spreader sprayer is improved;
the vehicle-mounted spraying assembly is set as a foldable structure, thereby increasing a spraying range. At the same time, when two ends of the spraying assembly encounter an obstacle, it can automatically switch to a folded state, thereby increasing an adaptability of the spraying assembly in a complex terrain environment;
the hopper is mounted on the flip bracket, which is convenient for inspection and maintenance of the spreading device;
the movable door and the opening regulation mechanism is arranged at the discharging port of the hopper, thereby controlling a discharging speed of the hopper to meet different requirements of sowing density;
the locking mechanism is arranged between the turning wheel and the frame, and the locking mechanism can lock the turning wheel at a specified angle, thereby ensuring that the spreader sprayer can move strictly along a predetermined path.

### BRIEF DESCRIPTION OF THE DRAWINGS

FIG. 1 is a controlling principle block view of a spreader sprayer according to at least one embodiment of the disclosure.

FIG. 2 is a perspective view of the spreader sprayer according to at least one embodiment of the disclosure.

FIG. 3 is a perspective view of the spreader sprayer from another angle according to at least one embodiment of the disclosure.

FIG. 4 is a top view of the spreader sprayer according to at least one embodiment of the disclosure.

FIG. 5 is a front view of the spreader sprayer according to at least one embodiment of the disclosure.

FIG. 6 is a side view of the spreader sprayer according to at least one embodiment of the disclosure.

FIG. 7 is a perspective view of a spraying device according to at least one embodiment of the disclosure.

FIG. 8 is one of the working schematic views of the spraying device according to at least one embodiment of the disclosure.

FIG. 9 is another one of the working schematic views of the spraying device according to at least one embodiment of the disclosure.

FIG. 10 is a perspective view of a vehicle-mounted chemical tank according to at least one embodiment of the disclosure.

FIG. 11 is a perspective view of the vehicle-mounted chemical tank from another angle according to at least one embodiment of the disclosure.

FIG. 12 is a side view of the vehicle-mounted chemical tank according to at least one embodiment of the disclosure.

FIG. 13 is a cross-sectional view of B-B in FIG. 12.

FIG. 14 is an exploded view of a water outlet connector according to at least one embodiment of the disclosure.

FIG. 15 is a perspective view of a discharging device according to a first embodiment of the disclosure.

FIG. 16 is a perspective view of a discharging device according to a second embodiment of the disclosure.

FIG. 17 is a perspective view of a vehicle-mounted spraying assembly according to a third embodiment of the disclosure.

FIG. 18 is a rear view and a partial enlarged view of the vehicle-mounted spraying assembly according to a third embodiment of the disclosure.

FIG. 19 is a top view and a partial enlarged view of the vehicle-mounted spraying assembly according to a third embodiment of the disclosure.

FIG. 20 is a perspective view of the vehicle-mounted spraying assembly in a folded state according to a third embodiment of the disclosure.

FIG. 21 is a top view and a partial enlarged view of the vehicle-mounted spraying assembly in the folded state according to a third embodiment of the disclosure.

FIG. 22 is a rear view and a partial enlarged view of the vehicle-mounted spraying assembly in the folded state according to a third embodiment of the disclosure.

FIG. 23 is a perspective view of a vehicle-mounted spraying assembly according to a fourth embodiment of the disclosure.

FIG. 24 is a perspective view of the vehicle-mounted spraying assembly in one of the folded states according to a fourth embodiment of the disclosure.

FIG. 25 is a perspective view of the vehicle-mounted spraying assembly in another folded state according to a fifth embodiment of the disclosure.

FIG. 26 is a perspective view of a frame according to at least one embodiment of the disclosure.

FIG. 27 is a perspective view of a spreading device according to at least one embodiment of the disclosure.

FIG. 28 is a perspective view of the spreading device from another angle according to at least one embodiment of the disclosure.

FIG. 29 is a front view of the spreading device according to at least one embodiment of the disclosure.

FIG. 30 is a cross-sectional view of A-A in FIG. 29.

FIG. 31 is a perspective view of a feeding part of the spreading device according to at least one embodiment of the disclosure.

FIG. 32 is an exploded view of the feeding part of the spreading device according to at least one embodiment of the disclosure.

FIG. 33 is a perspective view of an opening regulation mechanism according to at least one embodiment of the disclosure.

FIGS. 34, 35 are working schematic views of a landing regulation mechanism according to at least one embodiment of the disclosure.

FIGS. 36, 37 are working schematic views of a shielding mechanism according to at least one embodiment of the disclosure.

FIG. 38 is a partial enlarged view of part I in FIG. 26.

FIG. 39 is a perspective view of a hopper flipping mechanism in a state according to at least one embodiment of the disclosure.

FIG. 40 is a perspective view of the hopper flipping mechanism in another state according to at least one embodiment of the disclosure.

FIG. 41 is a side view of the hopper flipping mechanism in a state according to at least one embodiment of the disclosure.

FIG. 42 is a side view of the hopper flipping mechanism in another state according to at least one embodiment of the disclosure.

FIG. 43 is a side view of a stopping mechanism in a state according to at least one embodiment of the disclosure.

FIG. 44 is a side view of the stopping mechanism in another state according to at least one embodiment of the disclosure.

FIG. 45 is an exploded view of a third hinge shaft according to at least one embodiment of the disclosure.

FIG. 46 is a perspective view of a limiting mechanism according to at least one embodiment of the disclosure.

FIG. 47 is a perspective view of a locking mechanism according to at least one embodiment of the disclosure.

FIG. 48 is a perspective view and a partial enlarged view of the locking mechanism from another angle according to at least one embodiment of the disclosure.

FIG. 49 is an exploded view of the locking mechanism according to at least one embodiment of the disclosure.

FIG. 50 is a perspective view of the stopping mechanism of a turning wheel according to at least one embodiment of the disclosure.

FIG. 51 is a perspective view of the stopping mechanism of the turning wheel from another angle according to at least one embodiment of the disclosure.

FIG. 52 is a top view of the frame according to at least one embodiment of the disclosure.

FIG. 53 is a cross-sectional view of A-A in FIG. 52.

FIG. 54 is a perspective view of the turning wheel according to at least one embodiment of the disclosure.

FIG. 55 is a partial perspective view of the stopping mechanism of the turning wheel according to at least one embodiment of the disclosure.

### DETAILED DESCRIPTION

It should be noted that, expressions “front”, “rear”, “left” and “right” indicating directions in the disclosure are general terms for various directions of garden tools by those skilled in the art, which means that a forward direction of the garden tool is front, and a reverse direction is rear. A left hand side of an operator when riding on the garden tool is a left side, and a right hand side of an operator when riding on the garden tool is a right side.

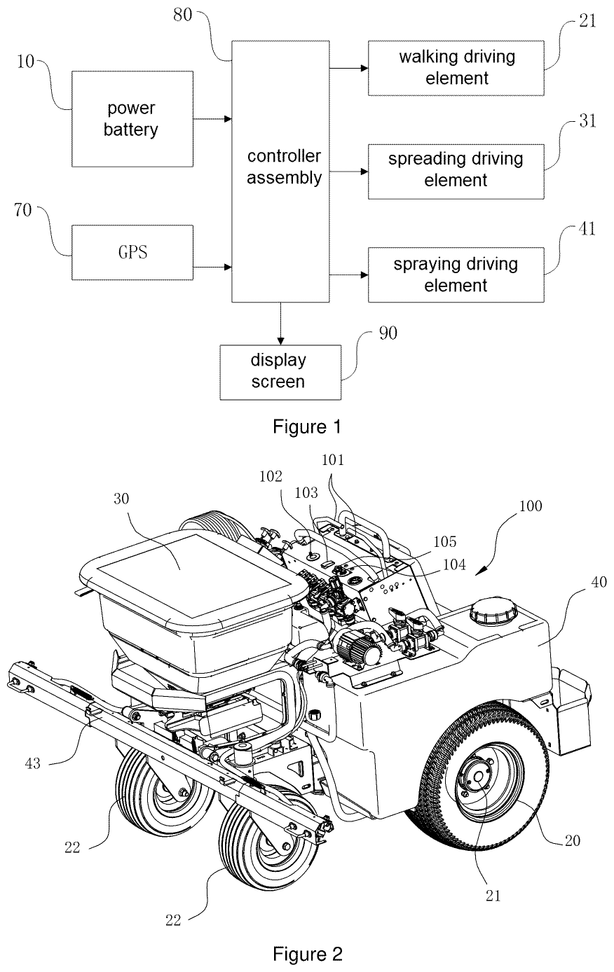

Please refer to FIG. 1. An embodiment of the disclosure provides a spreader sprayer. The spreader sprayer includes a frame 100, a power battery 10, a walking device, a spreading device, a spraying device and a controller assembly 80. The walking device, the spreading device, the spraying device and the controller assembly 50 are mounted on the frame 100. The walking device includes a walking driving part. 21. The spreading device includes a spreading driving part 31. The spraying device includes a spraying driving part 41. The power battery 10 is electrically connected with the controller assembly 80. The controller assembly 80 is electrically connected with the walking driving part 21, the spreading driving part 31 and the spraying driving part 41 respectively.

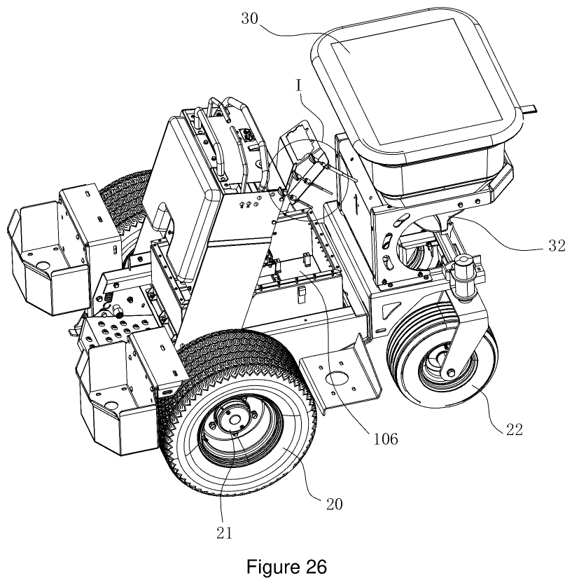

In an embodiment of the disclosure, the frame 100 is a standing frame, which means that the operator may stand on the frame 100 to control the spreader sprayer. However, it should be noted that, the disclosure has no particular limitation on a specific type of the frame 100. For example, in some other embodiments, the frame 100 may also be a sitting frame, a hand-propelled frame, or an unmanned frame. In an embodiment, the walking device may include, for example, at least two driving wheels 20, and the at least two driving wheels 20 are arranged on both sides of the frame 100. Please refer to FIG. 26. A battery pack compartment 106 for accommodating the power battery 10 is arranged on the frame 100.

The disclosure uses the power battery 10 as a power source of a whole vehicle. The controller assembly 80 can respond to user's operation to control a movement of the walking device, the spreading device and the spraying device. Since an electric driving method is adopted, there is no complicated transmission mechanism inside the whole vehicle, which can enable a structure of the spreader sprayer to be more compact, provide a basis for a miniaturized design of the whole vehicle, improve a flexibility of the spreader sprayer, and also provide a sufficient space for a mounting of the power battery 10, thereby ensuring an endurance of the whole vehicle. In addition, an electric driving mode further avoids air pollution and noise pollution caused by a traditional fuel driving mode, while reducing cost of care and maintenance. And it is compatible with most intelligent devices and adapts to a variety of intelligent application cases. For example, in conjunction with a GPS module 70 and an automatic driving program, it can realize an automatic tracking, path planning and other functions.

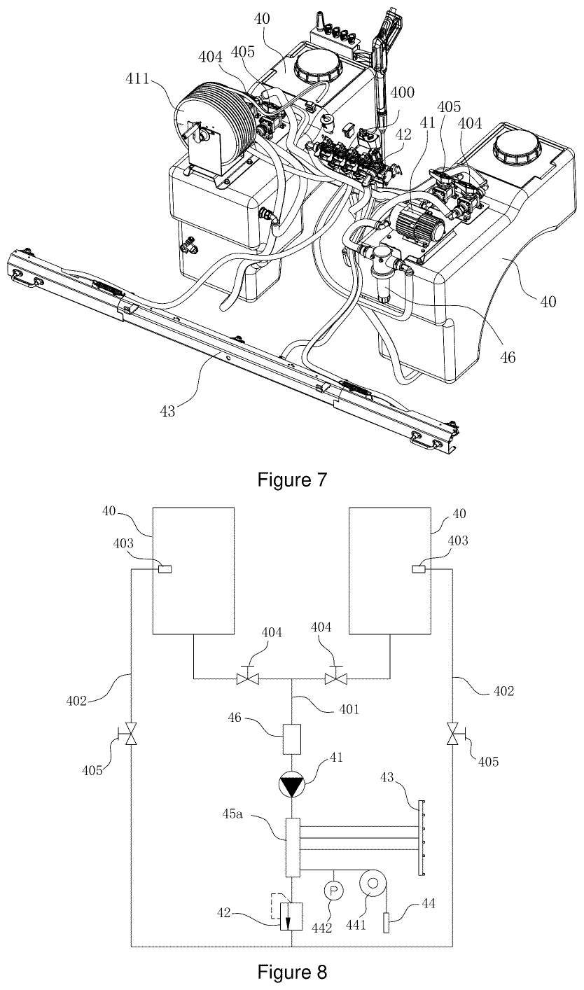

Please refer to FIG. 7. In an embodiment of the disclosure, the spraying device further includes a vehicle-mounted chemical tank 40, a vehicle-mounted spraying assembly 43, a hand-held spraying gun 44, a main pipeline 401 and a water divider valve assembly.

Please refer to FIG. 6 and FIG. 7. The vehicle-mounted chemical tank 40 is used to store working fluid, which may be, for example, pesticide, nutrient solution or water. In an embodiment, there are two vehicle-mounted chemical tanks 40, the two vehicle-mounted chemical tanks 40 are respectively mounted above the two driving wheels 20, and an arc groove is arranged at a bottom of the vehicle-mounted chemical tank 40 for avoiding the driving wheels. It should be understood that, on one hand, the arc groove can serve as a protective plate for the driving wheel 20 to prevent mud, water stains, etc. on the driving wheel 20 from being scattered everywhere. On the other hand, the arc groove can enable the bottom of the vehicle-mounted chemical tank 40 to gather to one side, so as to facilitate a full discharging of the working fluid in the vehicle-mounted chemical tank 40.

Please refer to FIG. 10 through FIG. 16. In an embodiment, the vehicle-mounted chemical tank 40 includes a housing, a box cover 4001 and a water outlet connector 4006. The housing is surrounded and formed by a bottom wall, a plurality of side walls and a top wall. The bottom wall includes an arc-shaped wall 4002, a first bottom wall 4003 and a second bottom wall 4004. The first bottom wall 4003 and the second bottom wall 4004 are connected with two ends of the arc-shaped wall 4002. The first bottom wall 4003 is lower than the second bottom wall 4004, and the first bottom wall 4003 and the second bottom wall 4004 both are lower than an arc top of the arc-shaped wall 4002. A drainage groove 4005 is arranged between the second bottom wall 4004 and the first bottom wall 4003, and the drainage groove 4005 is configured to enable liquid accumulated on the second bottom wall 4004 to flow to the first bottom wall 4003 through the drainage groove 4005 under an action of a gravity of the liquid. A water inlet is arranged on the top wall, and a water outlet is arranged on the first bottom wall 4003. The box cover 4001 is detachably mounted on the water inlet, and the water outlet connector 4006 is detachably mounted on the water outlet.

Please refer to FIG. 6 and FIG. 12. It should be understood that the first bottom wall 4003 and the second bottom wall 4004 are lower than the arc top of the arc-shaped wall 4002, which can enable the arc-shaped wall 4002 to have a larger surrounding angle with the wheel, so that the arc-shaped wall 4002 has a function of a fender. In order to ensure that medicine fluid can be fully discharged, the drainage groove 4005 is arranged between the two concave areas, so that the medicine fluid in a higher concave area which means the second bottom wall 4004, can flow into a lower concave area which means the first bottom wall 4003 through the drainage groove 4005, and the water outlet is arranged at the first bottom wall 4003, thereby ensuring that the medicine fluid in the chemical tank can be fully discharged.

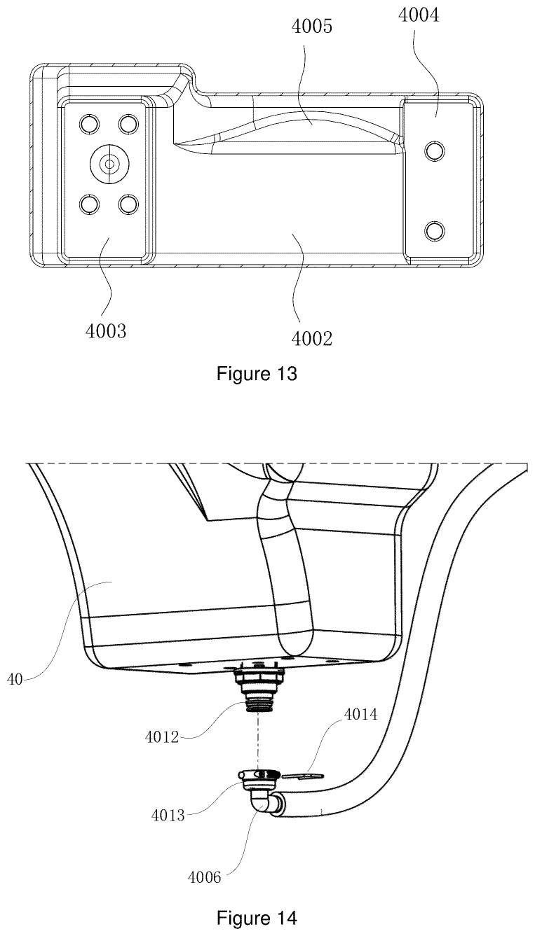

Please refer to FIG. 10, FIG. 12 and FIG. 13. In an embodiment, the drainage groove 4005 includes a downslope structure arranged from the second bottom wall 4004 to the first bottom wall 4003, and the drainage groove 4005 is arranged on at least one side of the arc-shaped wall 4002. It should be understood that in some other embodiments, the drainage groove 4005 may also be a communicating pipe arranged between the first bottom wall 4003 and the second bottom wall 4004, for example.

In a further embodiment, after the spreader sprayer is used, in order to quickly discharge the medicine fluid in the chemical tank, the disclosure further provides a discharging device at the bottom of the chemical tank.

Please refer to FIG. 16. In an embodiment, the discharging device may, for example, include a three-way directional valve arranged on the water outlet connector 4006. The three-way directional valve includes a liquid inlet, a first liquid outlet 4011 and a second liquid outlet 4010, and the three-way directional valve is configured to switch between following states: in a state one, the liquid inlet is communicated with the first liquid outlet 4011, and the liquid inlet is disconnected from the second liquid outlet 4010, in a state two, the liquid inlet is communicated with the second liquid outlet 4010, and the liquid inlet is disconnected from the first liquid outlet 4011. The first liquid outlet 4011 is communicated with a working pipeline, and the second liquid outlet 4010 is communicated with atmosphere. When the spreader sprayer is finished using, the three-way directional valve is switched from the state one to the state two to discharge all of the medicine fluid in the chemical tank.

Please refer to FIG. 14. In another embodiment, the discharging device, for example, may also be a quick connector connecting the water outlet connector 4006 and the water outlet. In one embodiment, the quick connector includes a male connector 4012 and a female connector 4013, the male connector 4012 is mounted at the water outlet, and the female connector 4013 is mounted at the water outlet connector 4006. The male connector 4012 and the female connector 4013 form a plug-in fit. The male connector 4012 and the female connector 4013 are respectively provided with positioning grooves and positioning holes mutually matched with each other. Length directions of the positioning groove and the positioning hole of the male connector 4012 are perpendicular to axis directions of the male connector 4012, and length directions of the positioning groove and the positioning hole of the female connector 4013 are perpendicular to axis directions of the female connector 4013. When the male connector 4012 and the female connector 4013 are plugged in, the positioning groove is aligned with the positioning hole, and a detachable positioning pin 4014 is arranged in the positioning groove and the positioning hole. When the spreader sprayer is finished using, the positioning pin 4014 is pulled out, and the male connector 4012 and the female connector 4013 may be quickly disassembled, thereby discharging all of the medicine fluid in the chemical tank.

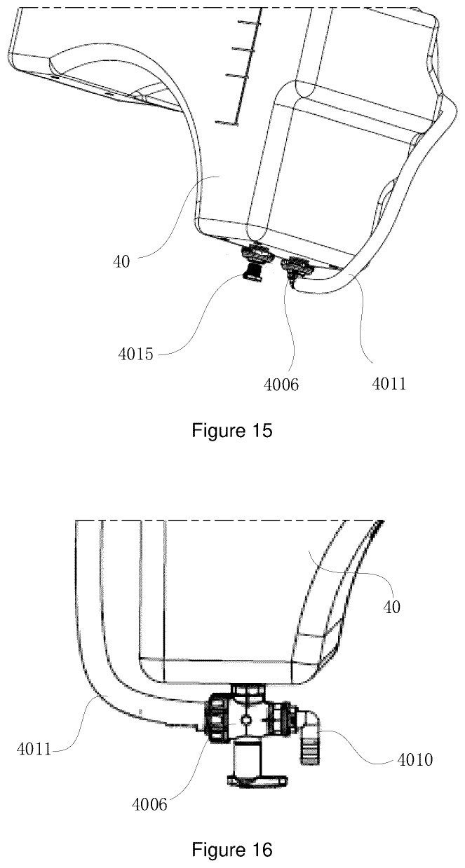

Please refer to FIG. 15. In an embodiment, the discharging device may also be an opening separately opened on the first bottom wall 4003. For example, the first bottom wall 4003 is further provided with a draining port, and the draining port is provided with a water blocking plug 4015. The water blocking plug 4015 is detachably connected with the draining port. In an embodiment, the water blocking plug 4015 and the draining port may be connected by threads, for example. When the medicine fluid needs to be drained, it is only necessary to unscrew the water blocking plug 4015.

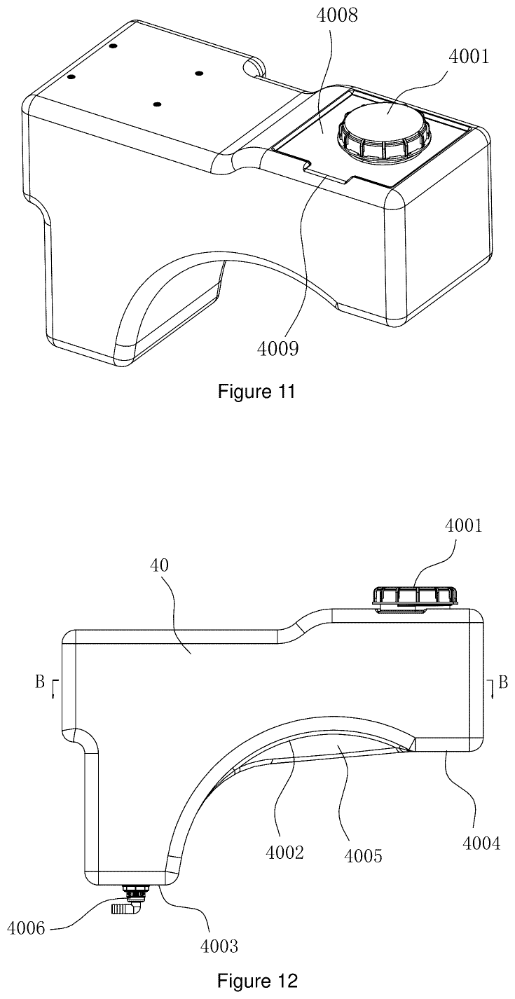

Please refer to FIG. 11. In an embodiment, a sinking groove 4008 is arranged on the top wall and is around the water inlet. A draining groove 4009 is arranged on at least one side edge of the sinking groove 4008. The draining groove 4009 extends to at least one side wall of the housing. It should be understood that, in the disclosure, the sinking groove 4008 is arranged around the water inlet, and the draining groove 4009 is arranged on one side of the sinking groove 4008. The draining groove 4009 may be arranged towards two sides of the spreader sprayer, for example. The spilled medicine fluid first gathers in the sinking groove 4008, and then is discharged to the two sides of the spreader sprayer through the draining groove 4009, thereby avoiding the medicine fluid from corroding a circuit or a transmission structure.

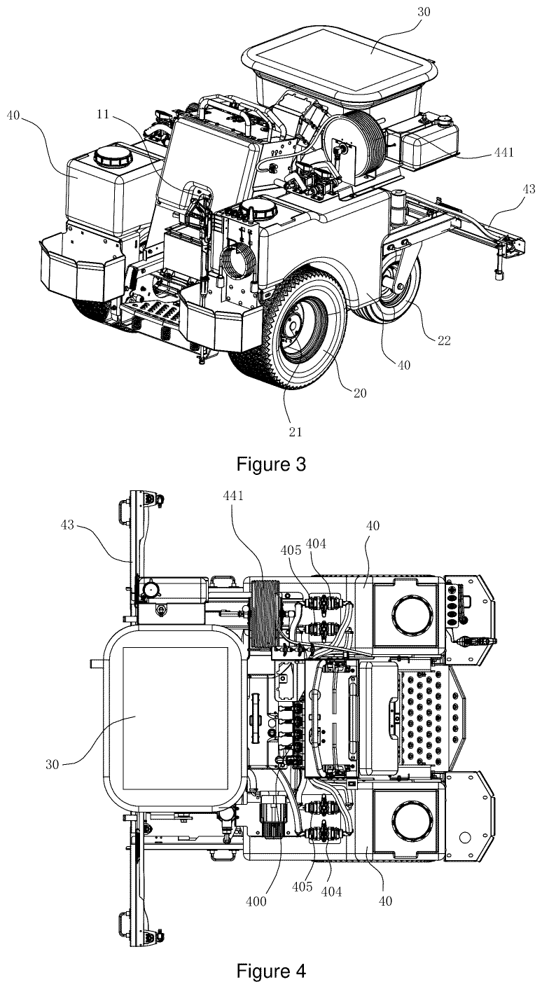

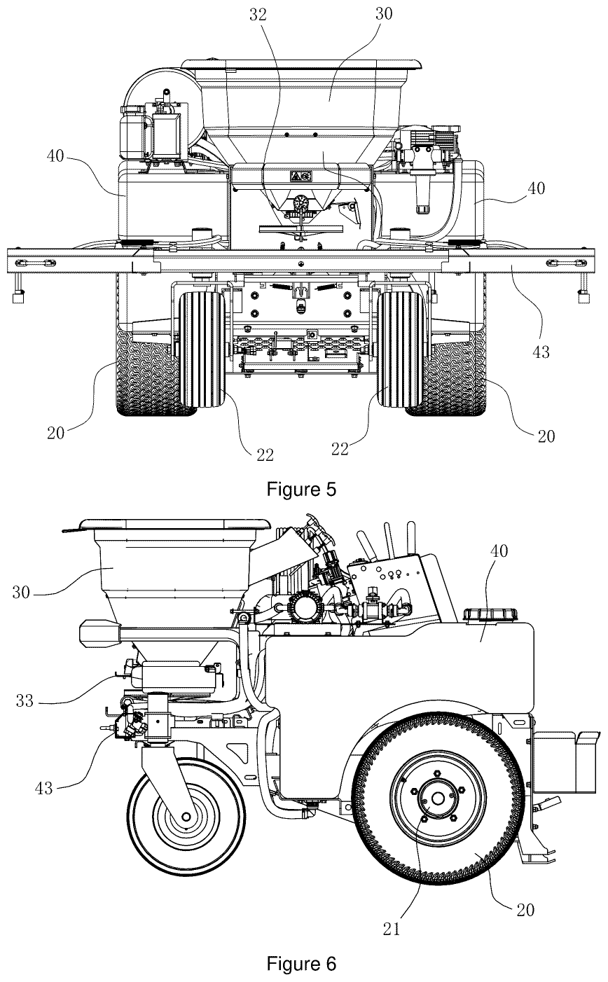

Please refer to FIG. 2 through FIG. 7. The vehicle-mounted spraying assembly 43 is mounted on the frame 100, and the vehicle-mounted spraying assembly 43 includes a plurality of spray nozzles. In an embodiment, the vehicle-mounted spraying assembly 43 includes a cross beam mounted horizontally at a front end of the frame 100, and the plurality of the spray nozzles arranged at intervals along a length direction of the cross beam. In another embodiment, in order to increase a width of a spraying area of the vehicle-mounted spraying assembly 43, the cross beam may be set to protrude from a side surface of the frame 100. At the same time, in order to avoid a protruding part of the cross beam affecting a passability of the frame 100, the protruding part of the cross beam may be set to a foldable structure.

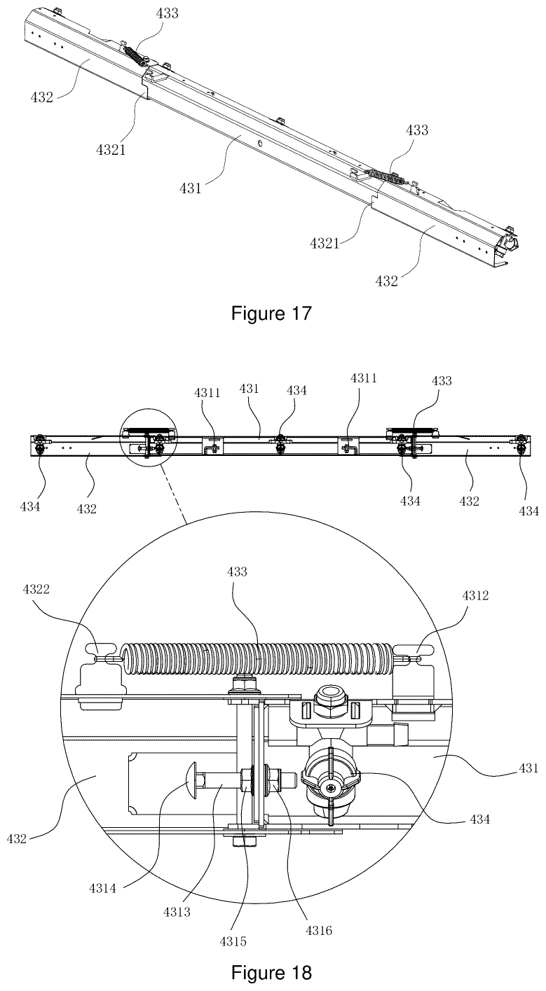

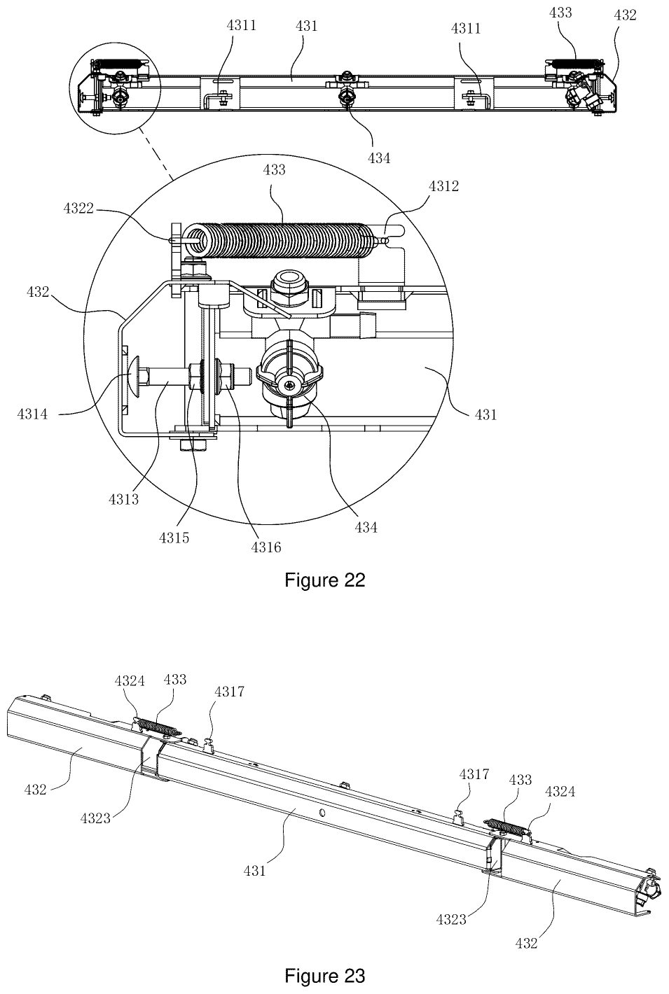

Please refer to FIG. 17 through FIG. 22. In an embodiment, the vehicle-mounted spraying assembly 43 includes a fixing arm 431, a movable arm 432, a holding mechanism and a spraying head 434. The fixing arm 431 includes a mounting part 4311 for connecting the vehicle frame 100. At least one movable arm 432 is movably mounted on at least one end of the fixing arm 431, and the movable arm 432 is assembled to be switchable between a first position and a second position, and when the movable arm 432 is switched from the first position to the second position, a distance that the movable arm 432 protrudes from an end part of the fixing arm 431 in a first direction may be reduced. The first direction is a width direction of the frame 100 connected with the fixing arm 431. The holding mechanism is mounted between the fixing arm 431 and the movable arm 432, and the holding mechanism is assembled to keep the movable arm 432 at the first position when it is in the first position, and when the movable arm 432 is subjected to an external force in a second direction, the movable arm 432 can be switched to the second position and held in the second position. The second direction is a direction forming an angle with the first direction. The plurality of the spray heads 434 are respectively mounted on the fixing arm 431 and the movable arm 432 along length directions of the fixing arm 431 and the movable arm 432.

In a preferred embodiment, the length direction of the fixing arm 431 may, for example, be parallel to the first direction, so that the fixing arm 431 obtains a widest arm span under a premise of a certain length. It should be noted that in some other embodiments, a possibility of tilting the fixing arm 431 according to actual usage requirements is not ruled out.

It should be understood that in actual application, the external force in the second direction may come from obstacles in a working environment, such as fences, trees, etc., or from a force actively applied by the operator to the movable arm 432. The spreader sprayer may adjust the movable arm 432 to the first position during operation, so that the vehicle-mounted spraying assembly has the wider arm span, thereby covering a larger spraying area. When there are obstacles on two sides of a movement path of the spreader sprayer, the movable arm 432 may interfere with the obstacle. At this time, the obstacle will generate a force in the second direction on the movable arm 432, thereby switching the movable arm 432 from the first position to the second position, and ensuring that the spreader sprayer can pass through the obstacle smoothly.

Please refer to FIG. 17 through FIG. 22. In an embodiment, the movable arm 432 is hinged to an end part of the fixing arm 431 through a first hinge shaft 435, so that the movable arm 432 can swing forward and backward relative to the spreader sprayer. In this embodiment, the movable arm 432 can increase the arm span of the vehicle-mounted spraying assembly when it swinging forward, and can reduce the arm span of the vehicle-mounted spraying assembly when it swinging backward. In a further embodiment, when the movable arm 432 is in the first position, it is collinear with the fixing arm 431, and when the movable arm 432 is in the second position, it is perpendicular to the fixing arm 431. However, it should be noted that, an angle between the movable arm 432 and the fixing arm 431 when the movable arm 432 is in the first position or an angle between the movable arm 432 and the fixing arm 431 when the movable arm 432 is in the second position are not fixed. As long as the movable arm 432 can change a total arm span of the vehicle-mounted spraying assembly 43 during a swinging process, it should fall within a range of protection of the disclosure. For example, in some other embodiments, the movable arm 432 may also be tilted forward or backward at a certain angle relative to the fixing arm 431 when it is in the first position.

Please refer to FIG. 17 and FIG. 18. In an embodiment, a first limiting part and a second limiting part for limiting a swinging angle of the movable arm 432 are arranged between the movable arm 432 and the fixing arm 431. In one embodiment, the first limiting part includes a protruding part 4321 arranged on the movable arm 432. When the movable arm 432 is located at the first position, the protruding part 4321 abuts against the fixing arm 431. The second limiting part includes a blocking pin 4313 arranged at the end part of the fixing arm 431. When the movable arm 432 is located at the second position, the blocking pin 4313 abuts against the movable arm 432. A main function of the first limiting part and the second limiting part is to enable the movable arm 432 to be controllable in the first position and the second position. It should be understood that a specific implementation method of the first limiting part and the second limiting part in the disclosure is not limited to the above-mentioned embodiment. As long as a swinging path of the movable arm 432 may be limited, the implementation method should fall within the range of protection required by the disclosure.

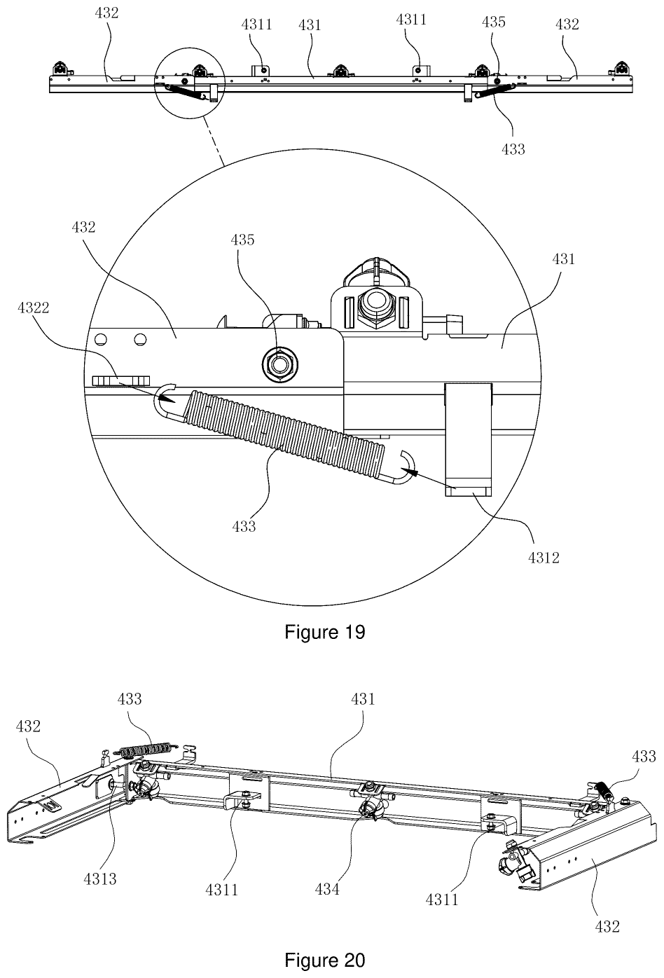

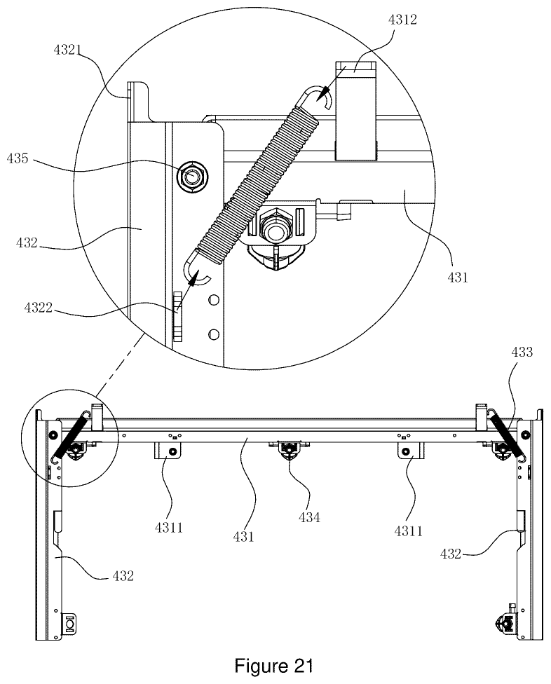

Please refer to FIG. 19 and FIG. 21. In an embodiment, the holding mechanism includes an elastic stretching unit 433, a first end of the elastic stretching unit 433 is connected with a first mounting point 4312 of the fixing arm 431, and a second end of the elastic stretching unit 433 is connected with a second mounting point 4322 of the movable arm 432. When the movable arm 432 is located at the first position, a line between the first mounting point 4312 and the second mounting point 4322 is located on a first side of an axis of the first hinge shaft 435. When the movable arm 432 is located at the second position, the line between the first mounting point 4312 and the second mounting point 4322 is located on a second side of the axis of the first hinge shaft 435, thereby ensuring that whether the movable arm 432 is in the first position or the second position, an elastic force of the elastic stretching unit 433 can hold the movable arm 432 at a current position and preventing the movable arm 432 from shaking. When the movable arm 432 is subjected to the external force, it is able to overcome the elastic force of the elastic stretching unit 433, causing the movable arm 432 to swing. During this process, the line between the first mounting point 4312 and the second mounting point 4322 will pass through the axis of the first hinge shaft 435, thereby enabling the elastic force of the elastic stretching unit 433 to hold the movable arm 432 in a new position.

Please refer to FIG. 18. In an embodiment, the blocking pin 4313 includes a threaded section. The fixing arm 431 is provided with a mounting hole for the blocking pin 4313 to pass through. The blocking pin 4313 is provided with a first nut 4315 and a second nut 4316. The first nut 4315 and the second nut 4316 are clamped at two ends of the mounting hole respectively. It should be understood that in this embodiment, a protruding length of the blocking pin 4313 may be adjusted by adjusting relative positions of the blocking pin 4313 to the first nut 4315 and the second nut 4316, thereby adjusting the angle between the movable arm 432 and the fixing arm 431 when the movable arm 432 is in the second position. Furthermore, a ball head 4314 is arranged on an end of the blocking pin 4313 against the movable arm 432 to adapt to different angles of the movable arm 432.

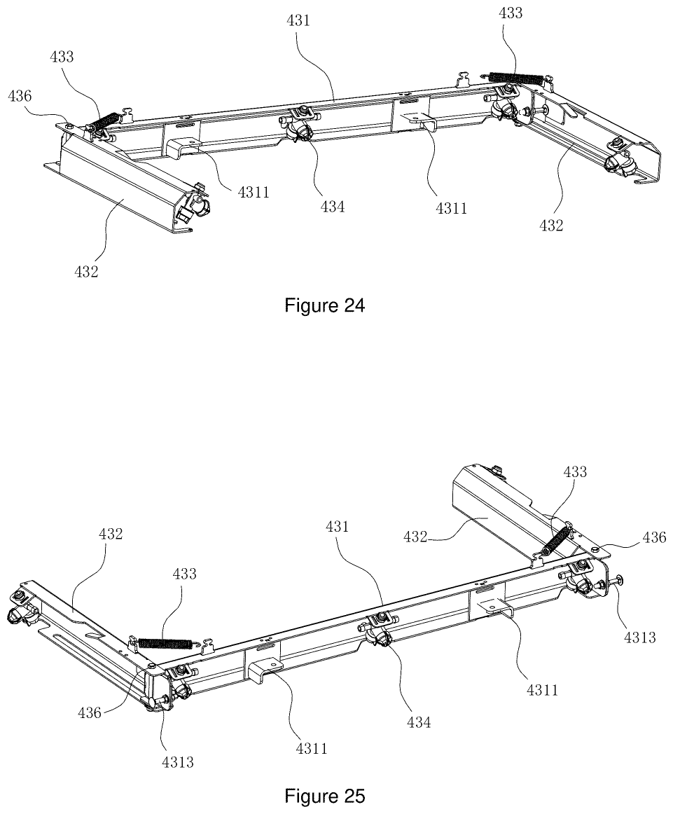

Please refer to FIG. 23 through FIG. 25. In another embodiment, the movable arm 432 of the vehicle-mounted spraying assembly 43 may also be flipped forward to reduce the arm span so as to avoid obstacles during a backward movement of the spreader sprayer. In one embodiment, the movable arm 432 is configured to be switchable between the first position, the second position and the third position, and when the movable arm 432 is switched from the first position to the second position or the third position, the distance that the movable arm 432 protrudes from the end part of the fixing arm 431 in the first direction can be reduced. The holding mechanism is mounted between the fixing arm 431 and the movable arm 432, configured to hold the movable arm 432 in the first position when the movable arm 432 is at the first position, configured to switch the movable arm 432 to the second position and hold the movable arm 432 at the second position when the movable arm 432 is subjected to an external force in the second direction, and configured to switch the movable arm 432 to the third position and hold the movable arm 432 at the third position when the movable arm 432 is subjected to an external force in a third direction. An angle between the second direction and the first direction is greater than 0° and less than 180°, and an angle between the third direction and the first direction is greater than 180° and less than 360°.

It should be understood that, in practical applications, the external force in the second direction refers to the external force acting on the movable arm 432 from a front of the movable arm 432, and the external force in the third direction refers to the external force acting on the movable arm 432 from a rear of the movable arm 432.

Please refer to FIG. 25. In one embodiment, the movable arm 432 is hinged to the end part of the fixing arm 431 through a second hinge shaft 436. A third limiting part for limiting the swinging angle of the movable arm 432 is further arranged between the movable arm 432 and the fixing arm 431, and the third limiting part is assembled so that when the movable arm 432 swings from the first position to the third position, the third limiting part can block the movable arm 432 at the third position.

Please refer to FIG. 23. In an embodiment, the first end of the elastic stretching unit 433 can be connected with a third mounting point 4317 of the fixing arm 431, and the second end of the elastic stretching unit 433 is connected with a fourth mounting point 4324 of the movable arm 432. When the movable arm 432 is located in the first position, a line between the third mounting point 4317 and the fourth mounting point 4324 passes through an axis of the second hinge shaft 436. When the movable arm 432 is located in the second position, the line between the third mounting point 4317 and the fourth mounting point 4324 is located on a first side of the axis of the second hinge shaft 436. When the movable arm 432 is located in the third position, the line between the third mounting point 4317 and the fourth mounting point 4324 is located on a second side of the axis of the second hinge shaft 436.

Please refer to FIG. 23. In one embodiment, the third limiting part includes a notch part 4323 arranged on the movable arm 432. When the movable arm 432 is located at the third position, the notch part 4323 abuts against the fixing arm 431. Similarly, a specific implementation method of the third limiting part in the disclosure is also not limited to the above-mentioned embodiment. As long as a swinging path of the movable arm 432 may be limited, the implementation method should fall within the range of protection required by the disclosure.

The disclosure arranges an anti-slid washer between the fixing arm 431 and the movable arm 432. When the movable arm 432 is in the first position, a friction between the anti-slid washer and the fixing arm 431 and a friction between the anti-slid washer and the movable arm 432 can keep the movable arm 432 in the first position. The movable arm 432 will only move when the external force applied to the movable arm 432 is sufficient to overcome the friction, thereby ensuring a stability of the movable arm 432 in the first position.

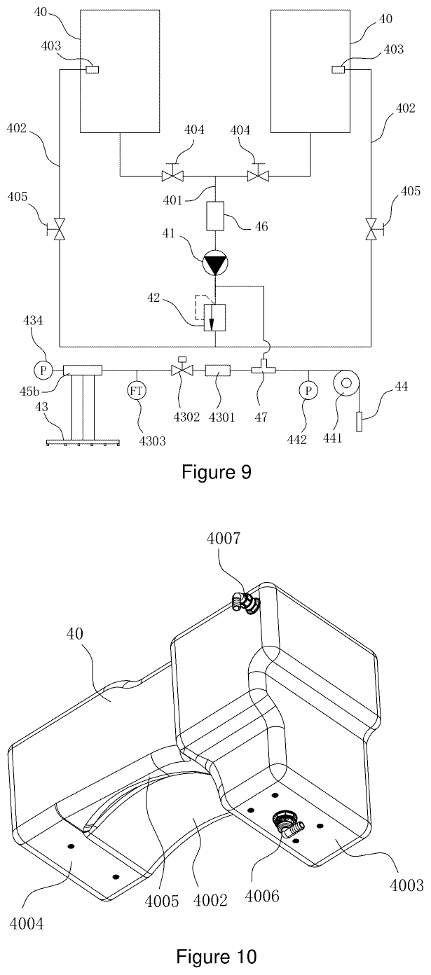

Please refer to FIG. 8 and FIG. 9. One end of the main pipeline 401 is communicated with the vehicle-mounted chemical tank 40, and the spraying driving part 41 is connected in series to the main pipeline 401. In an embodiment, the spraying driving part 41 may be, for example, a water pump. There is no special restriction on a specific type of the water pump, for example, it may be a plunger pump, a diaphragm pump or a centrifugal pump.

Please refer to FIG. 8 and FIG. 9. The water divider valve assembly includes a liquid inlet end and a plurality of liquid outlet ends, the liquid inlet end is communicated with the main pipeline 401, and each of the liquid outlet ends is respectively communicated with each spray nozzle of the vehicle-mounted spraying assembly 43 and the hand-held spraying gun 44. In an embodiment of the disclosure, the water divider valve assembly may, for example, control an on-off state of each water outlet pipe.

Please refer to FIG. 8 and FIG. 9. In an embodiment of the disclosure, the spreader sprayer further includes a return pipe 402 and a stirring nozzle 403. The stirring nozzle 403 is mounted in the vehicle-mounted chemical tank 40, a first end of the return pipe 402 is communicated with the stirring nozzle 403, and a second end of the return pipe 402 is connected with an upstream or a downstream of the water divider valve assembly.

The return pipe 402 arranged in the disclosure can allow excess working fluid to flow back into the vehicle-mounted chemical tank 40 to avoid a water pipe overload. At the same time, since the return pipe 402 of the disclosure is connected with the stirring nozzle 403, the returned working fluid can stir the working fluid of the vehicle-mounted chemical tank 40, so that the working fluid in the vehicle-mounted chemical tank 40 is mixed more evenly.

At the same time, in order to prevent the working fluid in the main pipeline 401 from directly flowing back into the vehicle-mounted chemical tank 40 and causing pressure loss in each water outlet pipe of the water divider valve assembly, a safety valve 42 may be arranged on the return pipe 402. The safety valve 42 may be, for example, an overflow valve shown in FIG. 8 and FIG. 9.

An embodiment of the disclosure provides two connection methods for the return pipe 402, one of the connection methods is shown in FIG. 8. The return pipe 402 is connected with a downstream of the water divider valve assembly, which means that the working fluid in the main pipeline 401 first flows through the water divider valve assembly and then enters the return pipe 402. In this embodiment, the water divider valve assembly may be, for example, a manual water divider valve 45a, and the operator may manually control an on-off state of each water outlet pipe through the valve. In an embodiment, the manual water divider valve 45a may be, for example, a plurality of ball valves connected in parallel, or it may be an integrated valve assembly.

Please refer to FIG. 9. In another embodiment of the disclosure, the return pipe 402 is connected with an upstream of the water divider valve assembly. In this embodiment, the water divider valve assembly includes one three-way valve 47 and an electromagnetic water divider valve 45b, the three-way valve 47 includes a first port, a second port and a third port, the first port is communicated with the main pipeline 401, the second port is communicated with the hand-held spraying gun 44, and the third port is communicated with the electromagnetic water divider valve 45b. In an embodiment of the disclosure, a regulation valve 4302 and a flow meter 4303 are connected in series on a pipeline between the three-way valve and the electromagnetic water divider valve 45b, the electromagnetic water divider valve 45b is connected with a pressure sensor 434, and the electromagnetic water divider valve 45b, the regulation valve 4302, the flow meter 4303 and the pressure sensor 434 are electrically connected with the controller assembly 80 respectively.

The controller assembly 80 can obtain flow data and pressure data of the electromagnetic water divider valve 45b in real time, and these data can reflect a real-time working state of the electromagnetic water divider valve 45b. In a further embodiment, the controller assembly 80 further includes a display screen 90, and the display screen 90 is electrically connected with the controller assembly 80. State information of the electromagnetic water divider valve 45b, the regulation valve 4302, the flow meter 4303, and the pressure sensor 434 may be displayed in real time on the display screen 90.

Please refer to FIG. 7 through FIG. 9. In an embodiment of the disclosure, the spraying device further includes a reel 441. A pipeline between the water divider valve assembly and the hand-held spraying gun 44 is wound on the reel 441.

Please refer to FIG. 8 and FIG. 9. In an embodiment of the disclosure, a pressure gauge 442 is arranged on the pipeline between the water divider valve assembly and the hand-held spraying gun 44. A first filter 46 is arranged on a pipeline between the vehicle-mounted chemical tank 40 and the spraying driving part 41 to prevent the spraying head 434 from being blocked.

Please refer to FIG. 9. When the electromagnetic water divider valve 45b is used, a second filter 4301 is further arranged on the pipeline between the three-way valve 47 and the electromagnetic water divider valve 45b to further filter the working fluid to prevent impurities in the working fluid from damaging the electromagnetic water divider valve 45b.

In an embodiment, a water inlet valve 404 is arranged on the pipeline between the spraying driving part 41 and the vehicle-mounted chemical tank 40, and a return valve 405 is arranged on the return pipe 402. The water inlet valve 404 and the return valve 405 are respectively mounted above the vehicle-mounted chemical tank 40 and are within a reach of the operator in a driving seat. The water inlet valve 404 and the water return valve 405 can close the entire pipeline when the machine is idle to prevent foreign matter from entering the pipeline and causing damage to the machine. At the same time, the water inlet valve 404 and the return valve 405 can further cut off a waterway in time in an emergency to improve safety.

Please refer to FIG. 2 through FIG. 6 and FIG. 10. In an embodiment of the disclosure, the walking driving part 21 includes a hub motor arranged in a rim of the driving wheel 20. A turning wheel 22 is arranged at a front end or a rear end of the frame 100, and the hub motor can further reduce a horizontal size of the frame 100 and improve its passability.

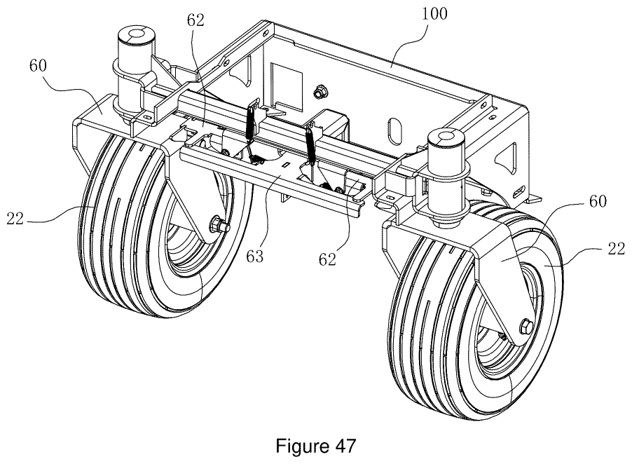

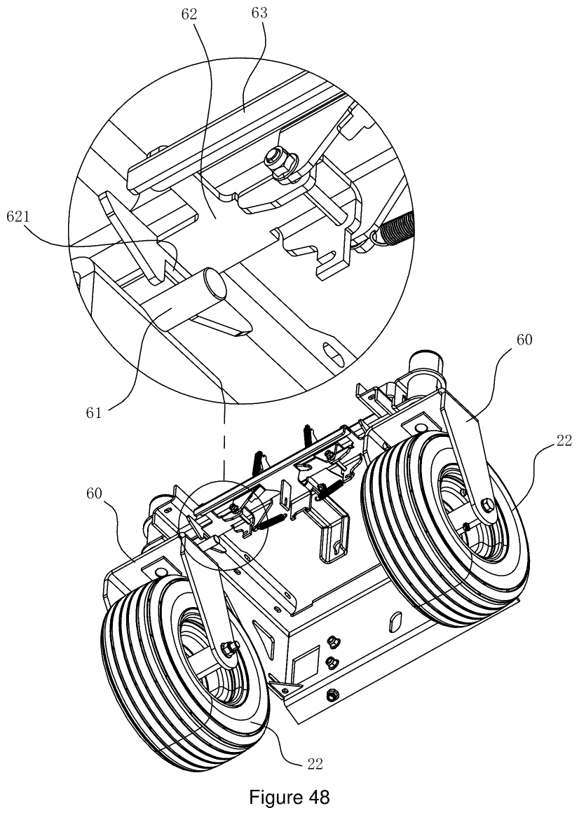

Please refer to FIG. 47 through FIG. 49. In an embodiment, the turning wheel 22 may be, for example, an unpowered universal wheel. In this case, a steering of the spreader sprayer may be controlled by controlling a rotating speed difference of the driving wheels 20 on two sides of the frame 100. However, in actual application, since the turning wheel 22 is in an unconstrained state, it may swing left and right when encountering an uneven ground, thereby causing a driving path of the spreader sprayer to deviate. For this reason, the disclosure is provided with a locking mechanism between the turning wheel 22 and the frame 100, which can lock the turning wheel 22 at a specified angle to ensure that the spreader sprayer can strictly follow a predetermined path.

Please refer to FIG. 47 through FIG. 49. In one embodiment, the turning wheel 22 is rotatably arranged on a steering bracket 60, and the steering bracket 60 is rotatably connected with the frame 100. The locking mechanism is mounted between the steering bracket 60 and the frame 100, and the locking mechanism is assembled to be switchable between following two positions: a locking station and a releasing station. In the locking station, the locking mechanism keeps a rotating bracket at a target steering angle when the rotating bracket is at the target steering angle, and in the releasing position, the locking mechanism releases the steering bracket 60 so that the steering bracket 60 can steer freely. It should be noted that, in an embodiment, the target steering angle may be, for example, 0°, which means that the turning wheel 22 is locked in a straight-ahead state, while in some other embodiments, the target steering angle may also be other angles, such as locking the turning wheel 22 in a left-turn state or a right-turn state so that the spreader sprayer can move along an arc path of a specified radius.

Please refer to FIG. 47 through FIG. 49. In an embodiment, the locking mechanism includes a first limiting unit and a second limiting unit.

Please refer to FIG. 47 through FIG. 49. In an embodiment of the disclosure, the first limiting unit includes a limiting pin 61 fixedly connected with the steering bracket 60, the second limiting unit includes a locking base 62 movably connected with the frame 100, a limiting groove 621 is arranged on the locking base 62, and when the steering bracket 60 is located at the target steering angle, the limiting pin 61 is located on a moving path of the limiting groove 621 to configure the limiting groove 621 to be clamped with or separated from the limiting pin 61.

Please refer to FIG. 47 through FIG. 49. In an embodiment, the locking base 62 is hinged with the frame 100, and an axis of a hinge shaft between the locking base 62 and the frame 100 is not parallel to a rotation axis of the steering bracket 60.

Please refer to FIG. 47 through FIG. 49. The locking mechanism further includes a retaining frame 63, and the retaining frame 63 is hinged with the frame 100 and assembled to be capable of swinging between a station I and a station II. The locking base 62 abuts against the retaining frame 63, when the retaining frame 63 swings from the station I to the station II, the limiting groove 621 can be clamped with the limiting pin 61 on the rotating bracket at the target steering angle, and when the retaining frame 63 swings from the station II to the station I, the limiting groove 621 can be separated from the limiting pin 61. The retaining frame 63 in this embodiment can be matched with the locking bases 62 of the two turning wheels 22 at the same time. At this time, only a state of the retaining frame 63 needs to be switched to simultaneously switch the states of the two locking bases 62, which provides convenience for a subsequent arrangement of the triggering mechanism.

In an embodiment, the frame 100 is provided with the triggering mechanism, and the triggering mechanism is in a transmission connection with the locking mechanism through a transmission mechanism to drive the locking mechanism to switch between the locking station and the releasing station.

In an embodiment, the triggering mechanism includes a pedal, and the transmission mechanism includes a connection rod. A first end of the connection rod is connected with the pedal, and a second end of the connection rod is connected with the retaining frame 63. The pedal, the connection rod and the retaining frame 63 are assembled so that when the pedal is stepped on, the retaining frame 63 can be driven by the connection rod to swing from a first external position to the station II. It should be noted that, specific forms of the triggering mechanism and the transmission mechanism are not limited to the above embodiments. For example, in some other embodiments, the triggering mechanism and the transmission mechanism may also be a combination of a handle and a pulling wire.

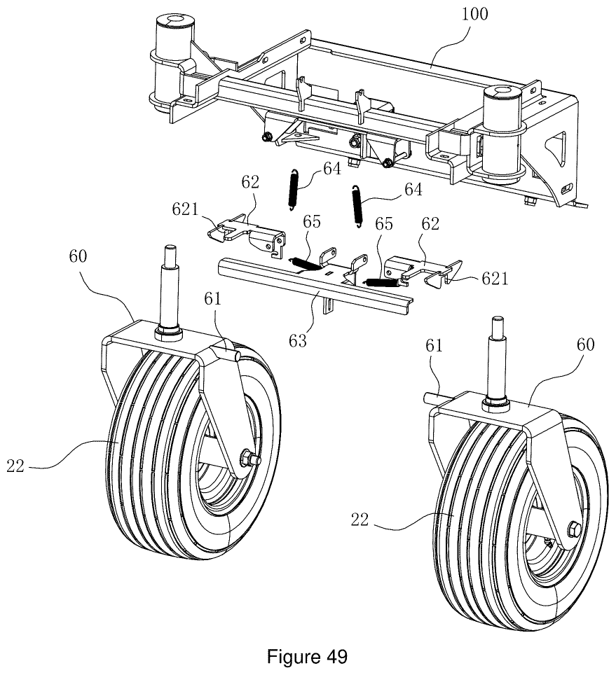

Please refer to FIG. 49. A second elastic member 64 is arranged between the retaining frame 63 and the frame 100, and the second elastic member 64 is configured such that its elastic force can drive the retaining frame 63 to swing from the station II to the position I. A third elastic member 65 is arranged between the locking base 62 and the retaining frame 63 or between the locking base 62 and the frame 100. The third elastic member 65 is configured so that its elastic force can drive the limiting groove 621 on the locking base 62 to be clamped with the limiting pin 61 on the rotating bracket at the target steering angle. In an embodiment, the second elastic member 64 and the third elastic member 65 can keep the locking mechanism in the releasing station, and when the triggering mechanism applies a force to the locking mechanism, the locking mechanism can be switched to the locking station.

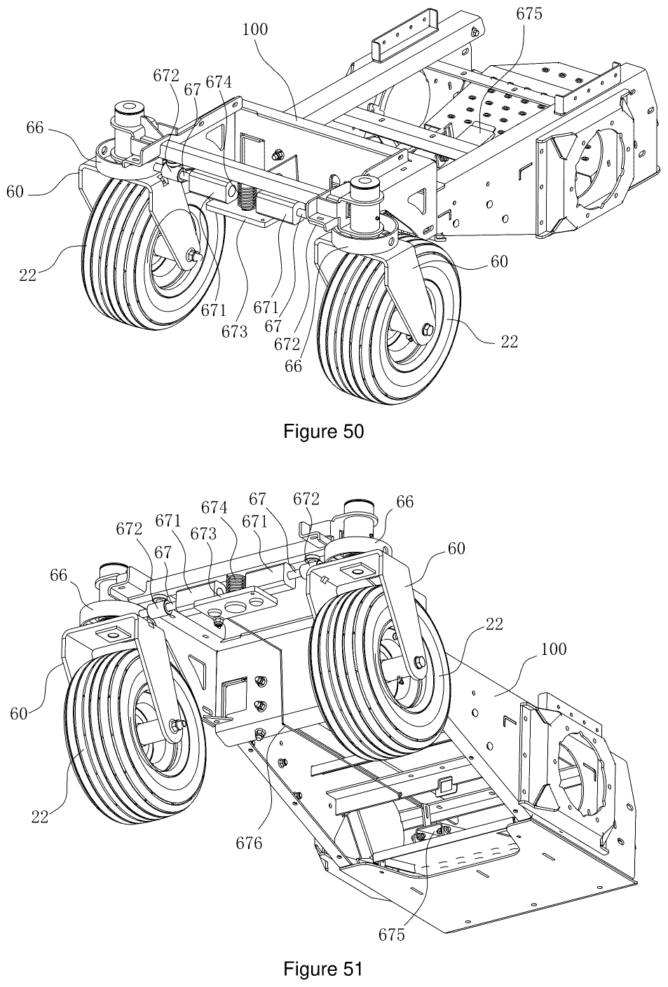

Please refer to FIG. 50 through FIG. 55. In another embodiment of the disclosure, the locking mechanism may include a guiding unit 66, a locking pin 67 and a fourth elastic member 677.

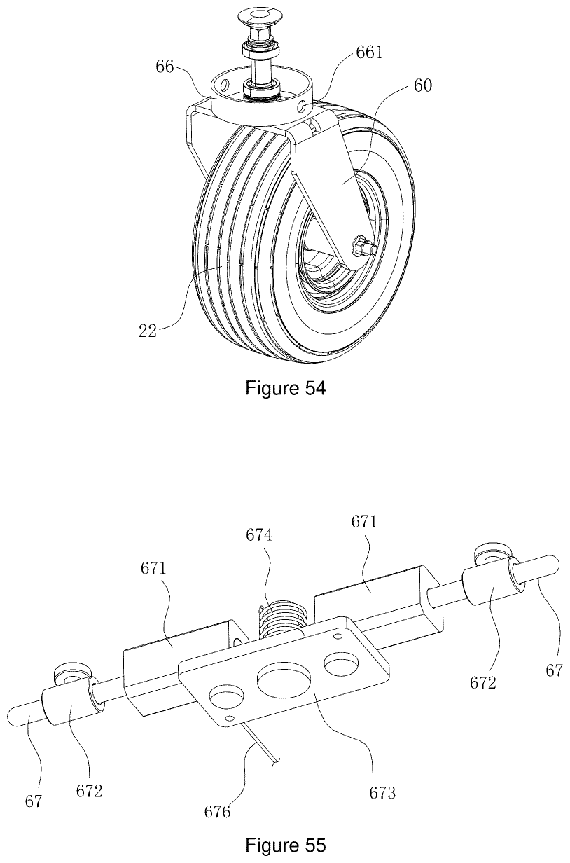

Please refer to FIG. 54. The guiding unit 66 is fixedly connected with the steering bracket 60 and provided with a guiding surface smoothly arranged along the circumference of a first axis, and a locking hole 661 is arranged on the guiding surface.

A function of the guiding surface is described in detail below in combination with the locking pin 67 and the fourth elastic member 677.

Please refer to FIG. 50, FIG. 51, FIG. 53 and FIG. 55. The locking pin 67 is movably connected with the frame 100 so that the locking pin 67 can abut against or move away from the guiding surface. When the locking pin 67 abuts against the guiding surface, the locking pin 67 is located on a rotation path of the locking hole 661 when the steering bracket 60 rotates. The fourth elastic member 677 is configured to generate an elastic force directed toward the guiding surface to the locking pin 67 at least when the locking pin 67 abuts against the guiding surface, in order to configure the locking pin 67 to be inserted into the locking hole 661 under an action of the elastic force when the locking hole 661 is aligned with the locking pin 67.

It should be understood that when the operator wants to lock the turning wheel 22, the turning wheel 22 is not necessarily located at a preset locking angle. At this time, when the operator controls the locking pin 67 to approach the guiding unit 66, the locking pin 67 will abut against the guiding surface. Due to the fourth elastic member 677, an interaction force between the locking pin 67 and the guide surface always exists. Although the turning wheel 22 may still swing left and right at this time, under a control of the operator, the turning wheel 22 will inevitably pass through the above-mentioned preset locking angle. At this time, due to an action of the fourth elastic member 677, the locking pin 67 will quickly bounce into the locking hole 661, thereby keeping the turning wheel 22 at the preset angle.

In an embodiment, the turning wheel 22 is locked in the straight-ahead state to keep the garden tool moving in a straight line. In other embodiments, the turning wheel 22 may be kept in a left-turn or right-turn state to keep the garden tool moving strictly along a circular path or an arc path.

Please refer to FIG. 50, FIG. 51, FIG. 53 and FIG. 55. In an embodiment, the locking mechanism further includes a movable base 671. The movable base 671 is movably connected with the frame 100 so that the movable base 671 can approach or move away from the guiding surface. The locking pin 67 is movably connected with the movable base 671 along its own axis direction. The fourth elastic member 677 is arranged between the locking pin 67 and the movable base 671. When the operator wants to lock the turning wheel 22, the operator may first drive the movable base 671 to approach the guiding unit 66, and the locking pin 67 first moves synchronously with the movable base 671. When the locking pin 67 abuts against the guiding surface, due to the fourth elastic member 677, the movable base 671 may continue to move a distance and store energy for the fourth elastic member 677. When the locking hole 661 is aligned with the locking pin 67, the fourth elastic member 677 can release potential energy and drive the locking pin 67 to quickly bounce into the locking hole 661, thereby locking the turning wheel 22.

Please refer to FIG. 55. In an embodiment, the locking mechanism further includes a driving base 673 and a guiding sleeve 672. The driving base 673 and the guiding sleeve 672 are rotatably connected with the frame 100 along a second axis and a third axis respectively, and the second axis is parallel to the third axis. The movable base 671 is rotatably connected with the driving base 673, and the locking pin 67 is slidably connected with the guiding sleeve 672 along its own axis direction. This embodiment uses a crank mechanism to drive the locking pin 67 to move, and its transmission structure is simple, which is convenient for driving through structures such as pedals and handles. It should be understood that a movement mode of the locking pin 67 is not limited to this embodiment. For example, in some other embodiments, the locking pin 67 may only perform a simple axial movement.

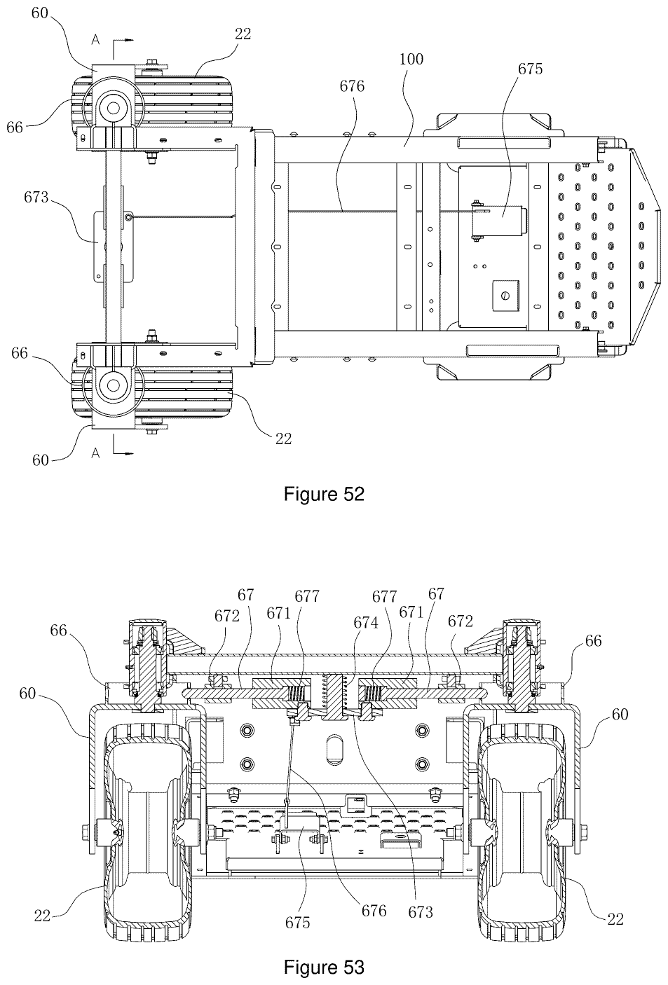

Please refer to FIG. 51, FIG. 52 and FIG. 53. The triggering mechanism of this embodiment includes a pedal 675 and a connection rod 676. The pedal 675 is movably connected with the frame 100. A first end of the connection rod 676 is connected with the pedal 675, and a second end of the connecting rod 676 is connected with the driving base 673.

Please refer to FIG. 55. In an embodiment, the triggering mechanism may further include a fifth elastic member 674, and the fifth elastic member 674 is configured such that its elastic force can drive the driving base 673 to rotate from a second rotation angle to a first rotation angle. In one embodiment, the fifth elastic unit may be, for example, a tension spring or a torsion spring, and its function is to drive the driving base 673 to reset when the operator releases the pedal 675.

Please refer to FIG. 54. In some embodiments, the guiding surface includes a cylindrical surface or an arc surface, and an axis of the cylindrical surface or an arc center line of the arc surface is parallel to or colinear with the first axis. It should be understood that since the fourth elastic member 677 is arranged between the locking pin 67 and the movable base 671 of the disclosure, the locking pin 67 may move within a certain range of moving, so the guiding surface does not have to be coaxial with the first axis, but is allowed to have a certain degree of ups and downs. However, considering a smoothness of the locking pin 67 when sliding on the guiding surface, in a preferred embodiment, the guiding surface is set to a cylindrical surface coaxial with the first axis. In this embodiment, the locking pin 67 is inserted into the locking hole 661 along a radial direction of the guiding unit 66. In some other embodiments, the guiding surface may also be an end surface of the guiding unit 66. Accordingly, it is only necessary to insert the locking pin 67 into the locking hole 661 from an axial direction of the guiding unit 66.

Please refer to FIG. 53 and FIG. 55. In an embodiment of the disclosure, there are two steering brackets 60, two the turning wheels 22, two guiding units 66, two locking pins 67, two fourth elastic members 677, two movable bases 671 and two guiding sleeves 672 arranged in a width direction of the frame 100. The two locking pins 67, the two fourth elastic members 677, the two movable bases 671 and the two guiding sleeves 672 are located between the two steering brackets 60, and the two movable bases 671 are connected with the same driving base 673. When the driving base 673 is located at the second rotation angle, the two locking pins 67 are in a coaxial state.

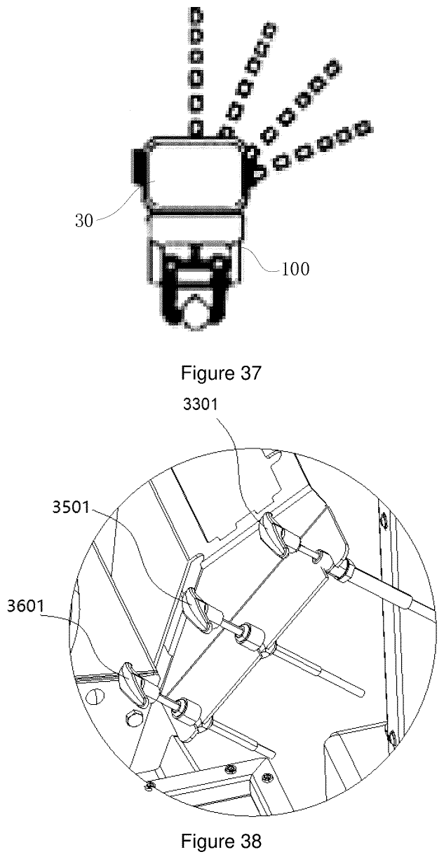

Please refer to FIG. 26 through FIG. 38. In an embodiment, the spreading device further includes a hopper 30, a movable door, an opening regulation mechanism and a spreading plate 32. A feeding port is arranged at an upper end of the hopper 30, and a discharging port is arranged at a lower end of the hopper 30. The movable door is mounted at the discharging port, and the movable door is movably arranged relative to the hopper 30 so that the movable door can open or close the discharging port. The opening regulation mechanism is mounted between the movable door and the hopper 30, and the opening regulation mechanism is configured to limit and regulate a moving path of the movable door to control an opening degree of the discharging port. The spreading plate 32 is located below the discharging port, the spreading plate 32 is rotatably arranged relative to the hopper 30, and the spreading plate 32 is connected with the spreading driving part 31.

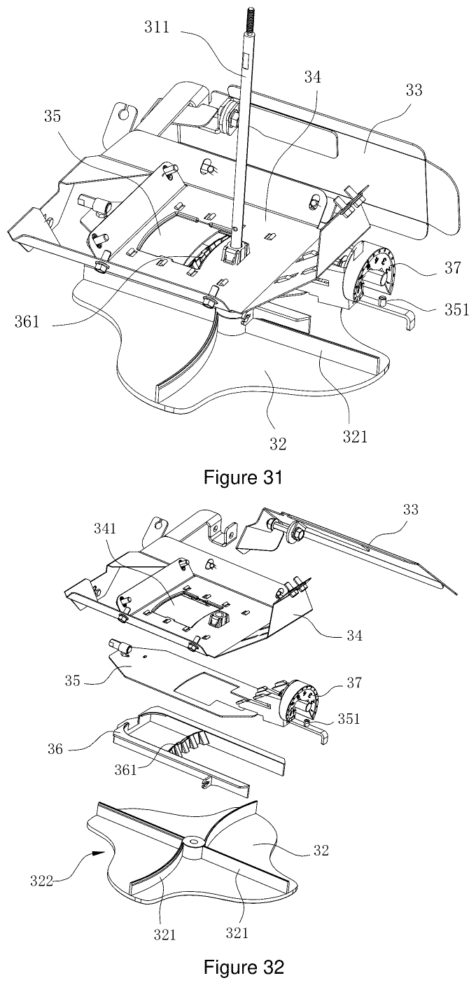

Please refer to FIG. 30 and FIG. 31. In an embodiment, a mounting plate 34 is arranged at a bottom of the hopper 30, and the mounting plate 34 is fixedly connected with the hopper 30. The discharging port may be arranged on the mounting plate 34, for example.

Please refer to FIG. 31 through FIG. 33. In an embodiment, the movable door includes a door panel 35 slidably arranged relative to the hopper 30 along a fourth direction, and a hollow part is arranged on the door panel 35. A position of the hollow part is configured to change a size of an overlapping area between the hollow part and the discharging port when the door panel 35 slides relative to the hopper 30. It should be understood that in some other embodiments, the door panel 35 may not be provided with the hollow part. For example, a shielding area of the discharging port by the door panel 35 may be changed directly by sliding the door panel 35, thereby controlling an opening and closing of the discharging port.

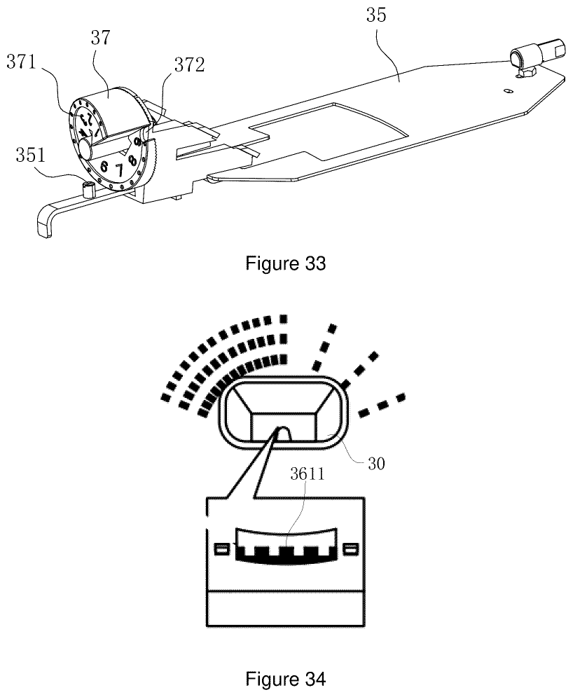

Please refer to FIG. 33. In an embodiment, the opening regulation mechanism includes a pin post 351 and a limiting base 37. The pin post 351 is relatively connected with the door panel 35 fixedly. The limiting base 37 includes a limiting surface 371. The limiting surface 371 is located on a movement path of the pin post 351 when it moves with the door panel 35. The limiting base 37 is movably arranged relative to the hopper 30 so that a position of an area on the limiting surface 371 that contacts the pin post 351 in the fourth direction may be regulated. In an embodiment, the limiting base 37 is rotatably arranged relative to the hopper 30, and a rotation axis is arranged along the fourth direction. The limiting surface 371 includes a spiral surface arranged around the rotation axis of the limiting base 37. In this embodiment, an abutting position between the spiral surface and the pin post 351 in the fourth direction can be changed through rotating the limiting base 37, thereby changing a maximum opening degree of the door panel 35. An advantage of this embodiment is that the opening degree of the door panel 35 can be linearly regulated. In an embodiment, the limiting base 37 is further provided with a through groove 372 for the pin post 351 to pass freely. The through groove 372 is located between two end parts of the spiral surface. When the pin post 351 is opposite to the through groove 372, the limiting base 37 will not interfere with a sliding of the door panel 35. At this time, the door panel 35 can be opened to a maximum design path.

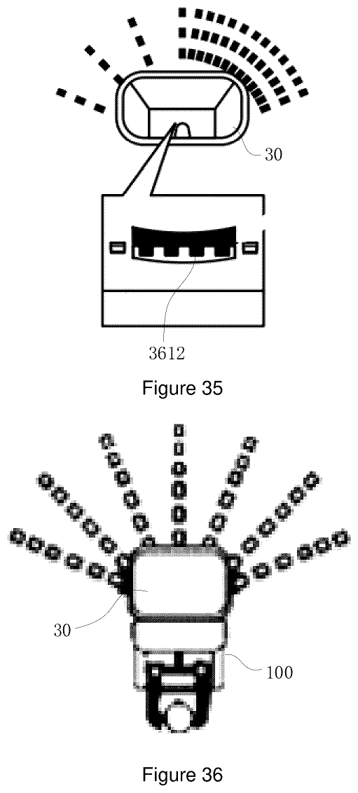

Please refer to FIG. 31, FIG. 32, FIG. 34 and FIG. 35. In an embodiment of the disclosure, the spreader sprayer further includes a landing regulation mechanism. The landing regulation mechanism includes a first guiding part and a second guiding part, the first guiding part is configured to guide materials discharged from the discharging port to a front half part of the spreading plate 32, the second guiding part is configured to guide the materials discharged from the discharging port to a rear half part of the spreading plate 32, the first guiding part and the second guiding part are mounted on a switching part, and the switching part is configured to be switchable between following two positions: a position a and a position b. In the position a, the first guiding part is located on a discharging path of the discharging port. In the position b, the second guiding part is located on a discharging path of the discharging port. The landing regulation mechanism can guide the material to fall in different directions, so that the material falls on different areas of the spreading plate 32. Please refer to FIG. 34 and FIG. 35. Taking a clockwise rotation as an example, when a landing point of the material on the spreading plate 32 is located in front of the spreading plate 32, most of the material will be thrown on a right side of the spreader sprayer after being thrown out by the spreading plate 32, and when the landing point of the material on the spreading plate 32 is located behind the spreading plate 32, most of the material will be thrown on a left side of the spreader sprayer after being thrown out by the spreading plate 32.

Please refer to FIG. 31, FIG. 32, FIG. 34 and FIG. 35. In an embodiment, the switching part includes a movable frame 36 slidably arranged relative to the hopper 30 along the fourth direction. The movable frame 36 is provided with a guiding beam 361. The first guiding part and the second guiding part respectively include a first inclined plane 3611 and a second inclined plane 3612 arranged on two sides of the guiding beam 361. Please refer to FIG. 35. When the guiding beam 361 is located at a front side of the discharging port, the second inclined plane 3612 is located on a material falling path, and the second inclined plane 3612 can guide the material to a rear half part of the spreading plate 32. Please refer to FIG. 34. When the guiding beam 361 is located at a rear side of the discharging port, the first inclined plane 3611 is located on the material falling path, and the first inclined plane 3611 can guide the material to a front half part of the spreading plate 32.

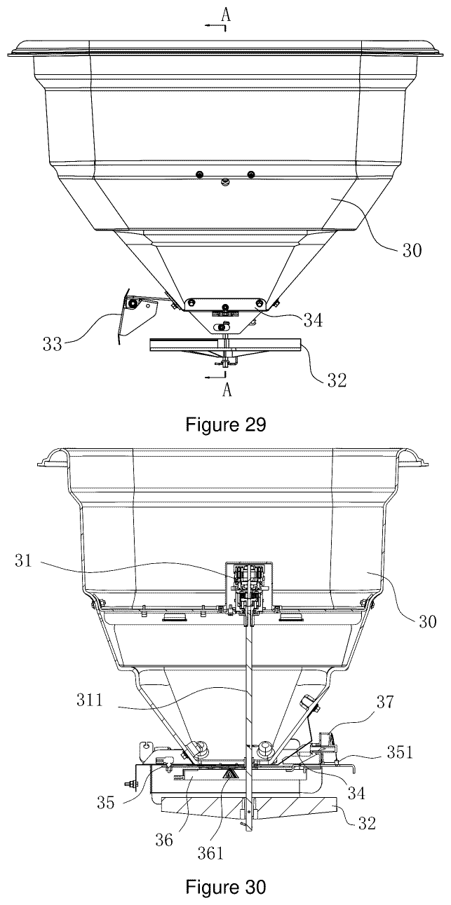

Please refer to FIG. 29, FIG. 31 through FIG. 37. In an embodiment of the disclosure, the spreader sprayer further includes a shielding mechanism. The shielding mechanism includes a blocking plate 33 arranged on at least one side of the spreading plate 32, and the blocking plate 33 is movably arranged relative to the hopper 30 to configure the blocking plate to be switchable between following two states: a state 1 and a state 2. In the state 1, the blocking plate 33 shields a part of a spreading path of the spreading plate. In the state 2, the blocking plate 33 avoids the spreading path of the spreading plate 32. In an embodiment, the blocking plate 33 may be arranged, for example, on the left or right side of the spreading plate 32, so that the blocking plate 33 can shield a left or right spreading path of the spreading plate 32, thereby reducing a width of a spreading area.

Please refer to FIG. 31 and FIG. 32. In an embodiment, the blocking plate 33 is rotably arranged relative to the hopper 30.

Please refer to FIG. 32. In an embodiment, the spreading plate 32 includes a plate body and a blade 321. The blade 321 is arranged on a surface of the plate body along a radial direction of the plate body. A plurality of blades 321 is arranged at intervals along a circumferential direction of the plate body. Between any two adjacent blades 321, one of the two adjacent blades 321 is an arc-shaped blade 321 and the other one of the two adjacent blades 321 is a straight blade 321. It should be understood that the spreading path generates by the blades 321 of different shapes are different. In fact, it is difficult to ensure a uniformity of material spreading by only one type of the blade 321. The embodiment combines the blades 321 of different shapes to superimpose multiple different spreading paths, thereby improving the uniformity of the material to a certain extent.

Please refer to FIG. 32. In an embodiment, edges of the plate body between any two adjacent blades 321 are respectively provided with a concave part 322 concaved toward a center of the plate body. An arrangement of the concave part 322 can enable part of the material to leave the spreading plate 32 earlier, thereby preventing most of the material from being accumulated on the blades 321, thereby further improving the uniformity of material spreading.

Please refer to FIG. 28 and FIG. 30. In an embodiment, a bracket is arranged in the hopper 30, and the spreading driving part 31 is mounted on the bracket. The spreading plate 32 is connected with the spreading driving part 31 through a rotating shaft. The spreading driving part 31 may be a motor, for example. A screen 301 is further arranged in the hopper to prevent large particles of debris from clogging the discharging port.

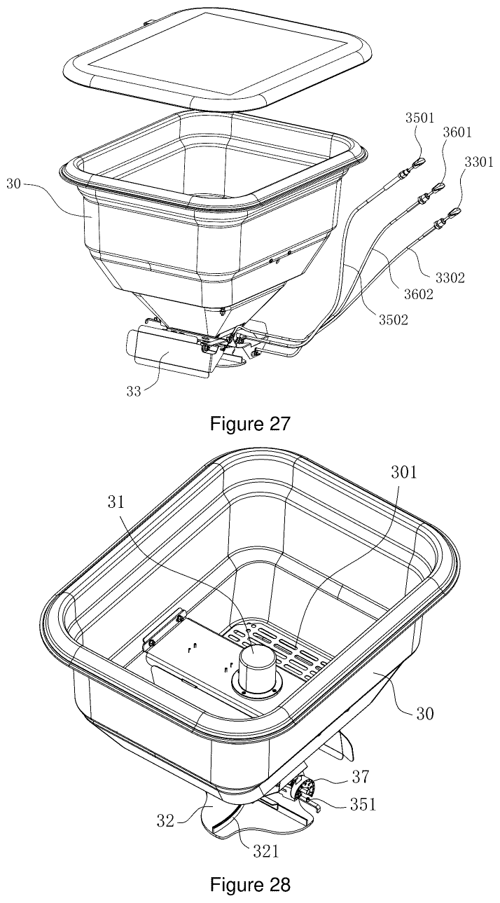

Please refer to FIG. 27 and FIG. 38. In an embodiment, the door panel 35, the movable frame 36 and the blocking plate 33 may be driven by a pulling wire mechanism, for example. In one embodiment, a first handle 3501 is arranged on the frame 100, and the door panel 35 is connected with the first handle 3501 through a first pulling wire 3502. A second handle 3601 is arranged on the frame 100, and the movable frame 36 is connected with the second handle 3601 through a second pulling wire 3602. A third handle 3301 is arranged on the frame 100, and the blocking plate 33 is connected with the third handle 3301 through a third pulling wire 3302.

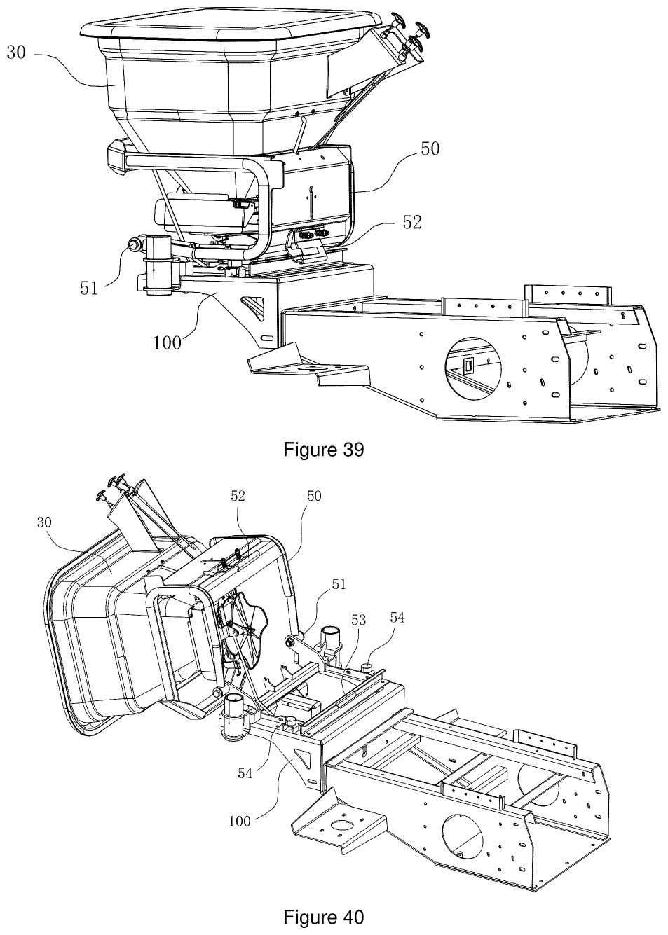

Please refer to FIG. 39 through FIG. 46. In an embodiment, in order to facilitate an inspection and maintenance of the spreading device and to empty the material in the hopper 30 after the spreader sprayer is finished working, the hopper 30 may be mounted on a flip bracket 50. In one embodiment, the flip bracket 50 is hinged with the frame 100. A limiting mechanism is arranged between the flip bracket 50 and the frame 100, and the limiting mechanism is configured to limit a flipping angle of the flip bracket 50 between a first angle and a second angle. A flipping path of the flip bracket 50 is shown as a in FIG. 42. The hopper 30 is configured so that the feeding port of the hopper 30 faces upward when the flip bracket 50 is at the first angle, and the feeding port of the hopper 30 faces downward when the flip bracket 50 is at the second angle. It should be noted that, in this embodiment, facing upward or downward does not necessarily mean vertically upward or vertically downward. In fact, when the flip bracket 50 is located at the first angle, it is only necessary that the material in the hopper 30 can be prevented from falling from the feeding port. Similarly, when the flip bracket 50 is located at the second angle, it is only necessary that the material in the hopper 30 can be discharged smoothly from the feeding port.

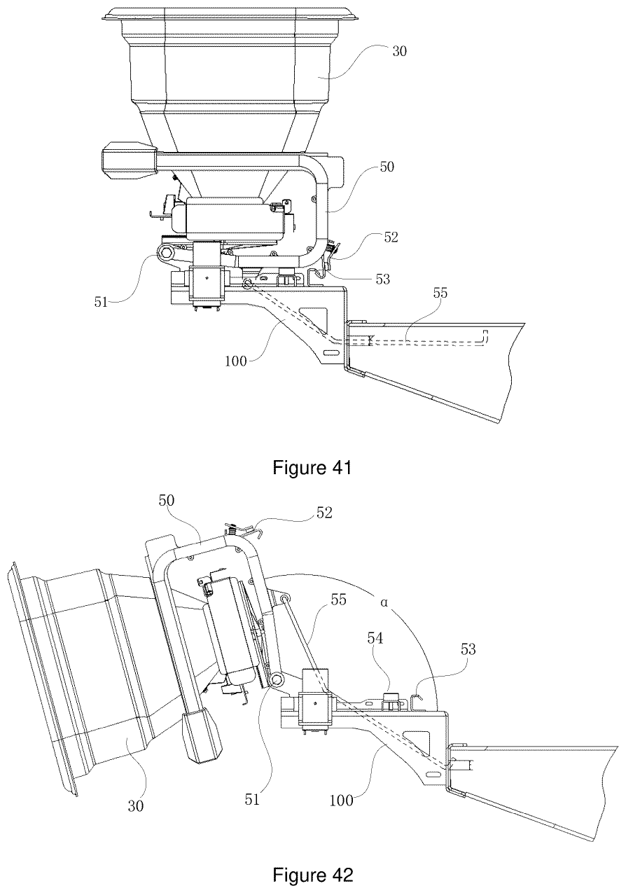

Please refer to FIG. 41 and FIG. 42. In one embodiment, the flip bracket 50 is hinged with the frame 100 through the third hinge shaft 51. When the flip bracket 50 is at a first angle, a center of gravity of a combination of the hopper 30 and the flip bracket 50 is located on a first side of a first vertical plane, and when the flip bracket 50 is at a second angle, the center of gravity of the combination of the hopper 30 and the flip bracket 50 is located on a second side of the first vertical plane. The first vertical plane is a vertical plane where an axis of the third hinge shaft 51 is located. In an illustrated embodiment, the third hinge shaft 51 is arranged along a width direction of the spreader sprayer, and the hopper 30 is arranged at a front end of the spreader sprayer, so that the hopper 30 may be flipped forward. In some other alternative embodiments, the hopper 30 may also be arranged at a tail part or two sides of the spreader sprayer according to actual space layout requirements, and its flipping direction may also be adjusted accordingly according to its mounting position.

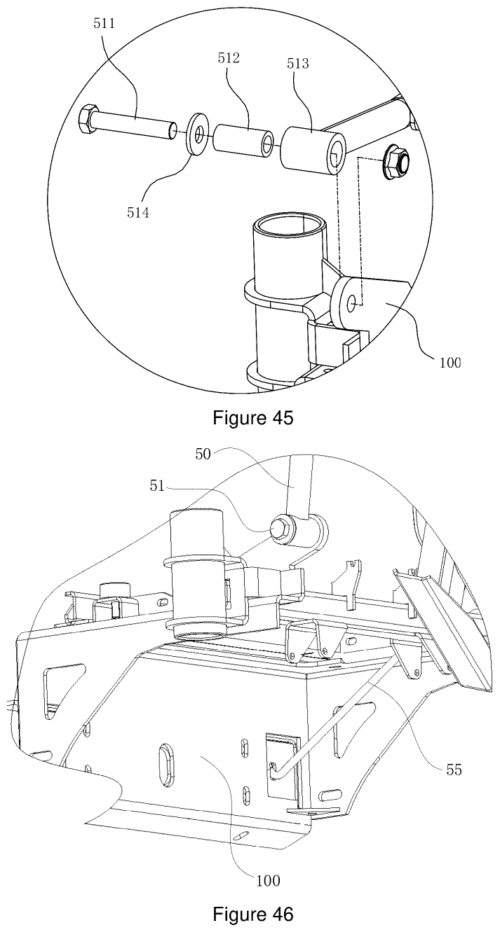

Please refer to FIG. 45. In an embodiment, the third hinge shaft 51 includes a separating sleeve 512, and the separating sleeve 512 is fixedly connected with the frame 100 through a bolt 511. A rotating sleeve 513 is arranged on the flip bracket 50, and the rotating sleeve 513 is hollowly sleeved on the separating sleeve 512. A length of the separating sleeve 512 is greater than a length of the rotating sleeve 513, and a retaining ring 514 is arranged at an end part of the separating sleeve 512. It should be understood that since the length of the separating sleeve 512 is greater than the length of the rotating sleeve 513, it can prevent the retaining ring 514 from pressing the rotating sleeve 513, thereby preventing the retaining ring 514 from hindering a rotation of the flip bracket 50.

Please refer to FIG. 40, FIG. 42 and FIG. 46. It should be understood that the limiting mechanism is mainly used to limit a flipping path of the flip bracket 50, so the limiting mechanism should at least include two parts, and these two parts respectively limit the flip bracket 50 to the first angle and the second angle. In an embodiment, the limiting mechanism may, for example, include a block 54 and a pulling rod 55. The block 54 is mounted on the frame 100, and is assembled so that when the flip bracket 50 is located at the first angle, the block 54 can abut against the flip bracket 50. At least an area of the block 54 that is in contact with the flip bracket 50 is made of elastic material. A first end of the pulling rod 55 is hinged with the flip bracket 50, and a second end of the pulling rod 55 is inserted into a limiting hole arranged on the frame 100. A hook part is arranged at the second end of the pulling rod 55 away from the flip bracket 50, and when the flip bracket 50 is located at the second angle, the hook part is hooked on an edge of the limiting hole. In addition to the above embodiments, the limiting mechanism may also be other types of blocking structures.

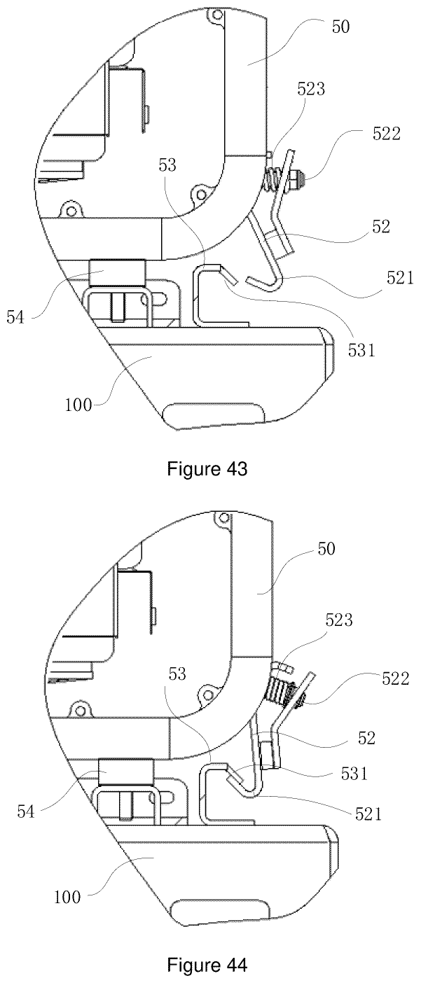

Please refer to FIG. 43 and FIG. 44. In an embodiment, a stopping mechanism is further arranged between the flip bracket 50 and the frame, and the stopping mechanism is configured to keep the flip bracket 50 at the first angle when the flip bracket 50 is at the first angle. In an embodiment, the locking mechanism may include, for example, a stopping base 53 and a stopping handle 52, the stopping base 53 is provided with a first hook part 531, the stopping handle 52 is provided with a second hook part 521, the stopping base 53 is fixedly connected with the frame 100, and the stopping handle 52 is movably connected with the flip bracket 50, so that the second hook part 521 can be hooked or separated from the first hook part 531. A movable screw rod 522 is arranged on the flip bracket 50, and the movable screw rod 522 forms a clearance fit with a mounting hole opened on the flip bracket 50. The stopping handle 52 is mounted on the movable screw rod 522, and a first elastic member 523 is arranged between the movable screw rod 522 and the stopping handle 52. The first elastic member 523 is assembled so that its elastic force can drive the stopping handle 52 to be tightly attached to the flip bracket 50.

Please refer to FIG. 2. In an embodiment of the disclosure, the frame 100 includes a driving seat, and the driving seat may be a standing driving seat or a sitting driving seat. The display screen 90 is mounted in front of the driving seat. An operating deck is further arranged in front of the driving seat. The operating deck is provided with a power supply switch 102, a walking operating rod 101, a spraying switch 103, a spreading switch 104, and a spreading regulation knob 105.

The above embodiments only illustrate principles and effects of the disclosure, but are not intended to limit the disclosure. Anyone familiar with this technology may modify or change the above embodiments without departing from a range of the disclosure. Therefore, all equivalent modifications or changes made by those with ordinary knowledge in the technical field without departing from the technical ideas disclosed in the disclosure shall still be covered by the claims of the disclosure.

What is claimed is:

1. A spreader sprayer, comprising:
a frame,
a walking device mounted on the frame, the walking device comprising a walking driving part;
a spreading device mounted on the frame, the spreading device comprising a spreading driving part;
a spraying device mounted on the frame, the spraying device comprising a spraying driving part;
a controller assembly mounted on the frame, the controller assembly being electrically connected with the walking driving part, the spreading driving part and the spraying driving part respectively, and the walking driving part, the spreading driving part and the spraying driving part are electric actuators respectively; and
a power battery arranged on the frame, the power battery being configured to provide electrical energy to the walking driving part, the spreading driving part and the spraying driving part.

2. The spreader sprayer according to claim 1, the spraying device further comprising:
a vehicle-mounted chemical tank used to store working fluid;
a vehicle-mounted spraying assembly mounted on the frame, the vehicle-mounted spraying assembly comprising a plurality of spray nozzles;
a hand-held spraying gun;
a main pipeline, one end of the main pipeline being communicated with the vehicle-mounted chemical tank, and the spraying driving part being connected in series to the main pipeline; and
a water divider valve assembly, the water divider valve assembly comprising a liquid inlet end and a plurality of liquid outlet ends, the liquid inlet end being communicated with the main pipeline, and each of the liquid outlet ends being respectively communicated with each spray nozzle of the vehicle-mounted spraying assembly and the hand-held spraying gun.

3. The spreader sprayer according to claim 2, further comprising a return pipe and a stirring nozzle, wherein, the stirring nozzle is mounted in the vehicle-mounted chemical tank, a first end of the return pipe is communicated with the stirring nozzle, and a second end of the return pipe is connected with an upstream or a downstream of the water divider valve assembly.

4. The spreader sprayer according to claim 3, wherein, the water divider valve assembly comprises a three-way valve and an electromagnetic water divider valve, the three-way valve comprises a first port, a second port and a third port, the first port is communicated with the main pipeline, the second port is communicated with the hand-held spraying gun, and the third port is communicated with the electromagnetic water divider valve.

5. The spreader sprayer according to claim 4, wherein, a regulation valve and a flow meter are connected in series on a pipeline between the three-way valve and the electromagnetic water divider valve, the electromagnetic water divider valve is connected with a pressure sensor, and the electromagnetic water divider valve, the regulation valve, the flow meter and the pressure sensor are electrically connected with the controller assembly respectively.

6. The spreader sprayer according to claim 5, further comprising a display screen, wherein, the display screen is electrically connected with the controller assembly, and is configured to at least display state information of the electromagnetic water divider valve and/or the regulation valve and/or the flow meter and/or the pressure sensor and driving information of the spreader sprayer.

7. The spreader sprayer according to claim 2, wherein, the walking device comprises at least two driving wheels, the at least two driving wheels are arranged on two sides of the frame, two vehicle-mounted chemical tanks are provided, the two vehicle-mounted chemical tanks are respectively mounted above the two driving wheels, and an arc groove is arranged at a bottom of the vehicle-mounted chemical tank to avoid the driving wheels.

8. The spreader sprayer according to claim 7, wherein, the walking driving part comprises a hub motor arranged in a rim of the driving wheel and a turning wheel mounted at a front end or a rear end of the frame.

9. The spreader sprayer according to claim 1, the spraying device further comprising:
a fixing arm, the fixing arm comprising a mounting part to be connected with the frame;
wherein at least one movable arm is movably mounted on at least one end of the fixing arm, the movable arm is configured to be switchable between a first position and a second position, and is capable of reducing a total length of the movable arm and the fixing arm in a first direction when the movable arm is switched from the first position to the second position, and the first direction being a width direction of the frame connected with the fixing arm; and
wherein a holding mechanism is mounted between the fixing arm and the movable arm, the holding mechanism is configured to hold the movable arm in the first position when the movable arm is at the first position, and is configured to switch the movable arm to the second position and hold the movable arm at the second position when the movable arm is subjected to an external force in a second direction, and the second direction is a direction forming an angle with the first direction; and
wherein a plurality of spraying heads is arranged on the fixing arm and the movable arm.

10. The spreader sprayer according to claim 9, wherein, the movable arm is hinged to an end part of the fixing arm through a first hinge shaft, a first limiting part and a second limiting part to limit a swinging angle of the movable arm are arranged between the movable arm and the fixing arm, the first limiting part is configured to block the movable arm at the first position when the movable arm swings from the second position to the first position, and the second limiting part is configured to block the movable arm at the second position when the movable arm swings from the first position to the second position.

11. The spreader sprayer according to claim 1, the spraying device further comprising:
a fixing arm comprising a mounting part to be connected with the frame;
wherein at least one movable arm movably mounted on at least one end of the fixing arm, the movable arm being configured to be switchable between a first position, a second position and a third position, and being capable of reducing a total length of the movable arm and the fixing arm in a first direction when the movable arm is switched from the first position to the second position or the third position, and the first direction being a width direction of the frame connected with the fixing arm; and
wherein a holding mechanism mounted between the fixing arm and the movable arm, the holding mechanism is configured to hold the movable arm in the first position when the movable arm is at the first position, and the holding mechanism is configured to switch the movable arm to a second position and hold the movable arm at the second position when the movable arm is subjected to an external force in the second direction, and the holding mechanism is configured to switch the movable arm to a third position and hold the movable arm at the third position when the movable arm is subjected to an external force in the third direction, an angle between the second direction and the first direction being greater than 0° and less than 180°, and an angle between the third direction and the first direction being greater than 180° and less than 360°, and
wherein a plurality of e spraying heads are arranged on the fixing arm and the movable arm.

12. The spreader sprayer according to claim 1, the spraying device comprising a vehicle-mounted chemical tank, and the vehicle-mounted chemical tank comprising:
a housing surrounded and formed by a bottom wall, a plurality of side walls and a top wall, the bottom wall comprising an arc-shaped wall, as well as a first bottom wall and a second bottom wall connected with two ends of the arc-shaped wall, the first bottom wall being lower than the second bottom wall, the first bottom wall and the second bottom wall being lower than an arc top of the arc-shaped wall, a drainage groove being arranged between the second bottom wall and the first bottom wall, the drainage groove being configured to enable liquid accumulated on the second bottom wall to flow to the first bottom wall through the drainage groove under an action of an gravity of the liquid, a water inlet being arranged on the top wall, and a water outlet being arranged on the first bottom wall;
a box cover being detachably mounted on the water inlet; and
a water outlet connector being detachably mounted on the water outlet.

13. The spreader sprayer according to claim 1, wherein, the spreading device is mounted on the frame and comprises:
a flip bracket is hinged to the frame;
a hopper is mounted on the flip bracket; and
a limiting mechanism is arranged between the flip bracket and the frame, and the limiting mechanism is configured to limit a flipping angle of the flip bracket between a first angle and a second angle; wherein
the hopper is configured such that a feeding port of the hopper faces upward when the flip bracket is located at the first angle, the feeding port of the hopper faces downward when the flip bracket is located at the second angle.

14. The spreader sprayer according to claim 1, wherein, the spreading device comprises:
a hopper, an upper end of the hopper is provided with a feeding port, and a lower end of the hopper is provided with a discharging port;
a movable door mounted at the discharging port, and the movable door is movably arranged relative to the hopper to enable the movable door to open or close the discharging port;
an opening regulation mechanism mounted between the movable door and the hopper, and the opening regulation mechanism is configured to limit and regulate a moving path of the movable door to control an opening size of the discharging port; and
a spreading plate located below the discharging port, the spreading plate is rotatably arranged relative to the hopper and is connected with the spreading driving part.

15. The spreader sprayer according to claim 14, further comprising a landing regulation mechanism, wherein, the landing regulation mechanism comprises a first guiding part and a second guiding part, the first guiding part is configured to guide materials discharged from the discharging port to a front half part of the spreading plate, the second guiding part is configured to guide the materials discharged from the discharging port to a rear half part of the spreading plate, the first guiding part and the second guiding part are mounted on a switching part, and the switching part is configured to be switchable between following two positions:
position a, the first guiding part being located on a discharging path of the discharging port when the switching part is in the position a; and
position b, the second guiding part being located on the discharging path of the discharging port when the switching part is in the position b.

16. The spreader sprayer according to claim 14, further comprising a shielding mechanism, wherein, the shielding mechanism comprises a blocking plate arranged on at least one side of the spreading plate, and the blocking plate is movably arranged relative to the hopper to configure the blocking plate to be switched between following two states:
state 1, the blocking plate in the state 1 shielding a part of a spreading path of the spreading plate; and
state 2 the blocking plate in the state 2 avoiding the spreading path of the spreading plate.

17. The spreader sprayer according to claim 1, wherein, the walking device is mounted on the frame and comprises:
a driving wheel and a turning wheel, the turning wheel being rotatably arranged on a steering bracket, and the steering bracket being rotatably connected with the frame; and
a locking mechanism, mounted between the steering bracket and the frame and configured to be switchable between following two stations:
a locking station, the locking mechanism in the locking station holding the steering bracket at a target steering angle when the steering bracket is at the target steering angle; and
a releasing station, the locking mechanism in the releasing station releasing the steering bracket to enable the steering bracket to be freely turned.

18. The spreader sprayer according to claim 17, wherein, the frame is provided with a triggering mechanism, and the triggering mechanism is in a transmission connection with the locking mechanism through a transmission mechanism to drive the locking mechanism to switch between the locking station and the releasing station.

19. The spreader sprayer according to claim 18, wherein, the locking mechanism comprises a first limiting unit and a second limiting unit, the first limiting unit comprises a limiting pin fixedly connected with the steering bracket, the second limiting unit comprises a locking base movably connected with the frame, a limiting groove is arranged on the locking base, and when the steering bracket is located at the target steering angle, the limiting pin is located on a moving path of the limiting groove to configure the limiting groove to be clamped with or separated from the limiting pin.

20. The spreader sprayer according to claim 17, wherein, the locking mechanism comprises:
a guiding unit fixedly connected with the steering bracket, the guiding unit is provided with a guiding surface smoothly arranged along the circumference of a first axis, and a locking hole being arranged on the guiding surface;
a locking pin movably connected with the frame, the locking pin is configured to abut against or move away from the guiding surface, and when the locking pin abuts against the guiding surface, the locking pin being located on a rotation path of the locking hole when the locking hole rotates with the steering bracket; and
elastic member, configured to generate an elastic force directed toward the guiding surface to the locking pin at least when the locking pin abuts against the guiding surface, in order to configure the locking pin to be inserted into the locking hole under an action of the elastic force when the locking hole is aligned with the locking pin.
